(19) United States
(12) Patent Application Publication
(10) Pub. No.: US 2011/0235175 A1
(43) Pub. Date: Sep. 29, 2011

(54) POLARIZATION CONVERTING COLOR COMBINER

(76) Inventors: Yarn Chee Poon, Singapore (SG); Andrew J. Ouderkirk, Singapore (SG); Philip E. Watson, Singapore (SG); Xiaohui Cheng, Singapore (SG); Zhisheng Yun, Woodbury, MN (US)

(21) Appl. No.: 13/129,893

(22) PCT Filed: Nov. 18, 2009
(86) PCT No.: PCT/US09/64931

§ 371 Date: Jun. 15, 2011

Related U.S. Application Data
(62) Division of application No. 61/116,072, filed on Nov. 19, 2008.
Application No. 61/116,072 is a division of application No. 61/116,061, filed on Nov. 19, 2008.

(51) Int. Cl. G02B 27/28

(52) U.S. Cl. 359/487.04

(57) ABSTRACT

Optical elements, color combiners using the optical elements, and image projectors using the color combiners are described. The optical elements can be configured as color combiners that receive different wavelength spectrums of light and produce a combined light output that includes the different wavelength spectrums of light. In one aspect, the received light inputs are unpolarized, and the combined light output is polarized in a desired state. In one aspect, the received light inputs are unpolarized, and the combined light output is also unpolarized. The optical elements can be configured to minimize the passage of light which may be damaging to wavelength-sensitive components in the light combiner. Image projectors using the color combiners can include imaging modules that operate by reflecting or transmitting polarized light.

### BACKGROUND

Projection systems used for projecting an image on a screen can use multiple color light sources, such as light emitting diodes (LED's), with different colors to generate the illumination light. Several optical elements are disposed between the LED's and the image display unit to combine and transfer the light from the LED's to the image display unit. The image display unit can use various methods to impose an image on the light. For example, the image display unit may use polarization, as with transmissive or reflective liquid crystal displays.

Still other projection systems used for projecting an image on a screen can use white light configured to imagewise reflect from a digital micro-mirror array, such as the array used in Texas Instruments' Digital Light Processor (DLP®) displays. In the DLP® display, individual mirrors within the digital micro-mirror array represent individual pixels of the projected image. A display pixel is illuminated when the corresponding mirror is tilted so that incident light is directed into the projected optical path. A rotating color wheel placed within the optical path is timed to the reflection of light from the digital micro-mirror array, so that the reflected white light is filtered to project the color corresponding to the pixel. The digital micro-mirror array is then switched to the next desired pixel color, and the process is continued at such a rapid rate that the entire projected display appears to be continuously illuminated. The digital micro-mirror projection system requires fewer pixelated array components, which can result in a smaller size projector.

Image brightness is an important parameter of a projection system. The brightness of color light sources and the efficiencies of collecting, combining, homogenizing and delivering the light to the image display unit all affect brightness. As the size of modern projector systems decreases, there is a need to maintain an adequate level of output brightness while at the same time keeping heat produced by the color light sources at a low level that can be dissipated in a small projector system. There is a need for a light combining system that combines multiple color lights with increased efficiency to provide a light output with an adequate level of brightness without excessive power consumption by light sources.

### SUMMARY

Generally, the present description relates to optical elements, color combiners using the optical elements, and image projectors using the color combiners. In one aspect, the present disclosure provides an optical element that includes a first color-selective dichroic filter having a first input surface, disposed to transmit a first light beam perpendicular to the first input surface and a second color-selective dichroic filter having a second input surface disposed to transmit a second light beam perpendicular to the second input surface. The optical element further includes a first reflective polarizer disposed to intercept the first light beam and the second light beam at an angle of approximately 45 degrees, and a second reflective polarizer disposed to intercept a second polarization state of the first and second light beam reflected from the first reflective polarizer, at an angle of approximately 45 degrees. The optical element still further includes a first retarder disposed between the first color-selective dichroic filter and the first reflective polarizer, and a second retarder disposed between the second color-selective dichroic filter and the first reflective polarizer. The optical element still further includes a reflector disposed so that a line normal to the reflector intercepts the second reflective polarizer at an angle of approximately 45 degrees, and a third retarder disposed between the second reflective polarizer and the reflector; wherein the first and second reflective polarizers, the reflector, and the retarders are disposed to convert a second polarization state of the first and second light beam into a first polarization state of the first and second light beams, respectively. In yet another aspect, the present disclosure provides a color combiner that includes the optical element. In yet another aspect, the present disclosure provides a display system that includes an imaging panel and the color combiner.

In another aspect, the present disclosure provides an optical element that includes a first reflective polarizer disposed to intercept a first light beam and a second light beam at an angle of approximately 45 degrees, and a second reflective polarizer disposed to intercept a second polarization state of the first and the second light beam reflected from the first reflective polarizer, at an angle of approximately 45 degrees. The optical element further includes a reflector disposed so that a line normal to the reflector intercepts the second reflective polarizer at an angle of approximately 45 degrees, and a retarder disposed between the second reflective polarizer and the reflector; wherein the first and second reflective polarizers, the reflector, and the retarder are disposed to convert a second polarization state of the first and the second light beam into a first polarization state of the first and the second light beams, respectively. In yet another aspect, the present disclosure provides a color combiner that includes the optical element. In yet another aspect, the present disclosure provides a display system that includes an imaging panel and the color combiner.

In yet another aspect, the present disclosure provides an optical element that includes a first color-selective dichroic filter having a first input surface, disposed to transmit a first light beam perpendicular to the first input surface and a second color-selective dichroic filter having a second input surface, disposed to transmit a second light beam perpendicular to the second input surface. The optical element further includes a first reflective polarizer disposed to intercept the first light beam and the second light beam at an angle of approximately 45 degrees, and a second reflective polarizer disposed to intercept a transmitted first and second light beams from the first reflective polarizer at an angle of approximately 45 degrees. The optical element still further includes a first reflector disposed so that a line normal to the first reflector intercepts the first reflective polarizer at an angle of approximately 45 degrees and a second reflector disposed so that a line normal to the second reflector intercepts the second reflective polarizer at an angle of approximately 45 degrees. The optical element still further includes a first and a second retarder disposed between the first and second color-selective dichroic filters, respectively, and the first reflective polarizer; and a fourth, and a fifth retarder disposed between the first reflector and the first reflective polarizer, and the second reflector and the second reflective polarizer, respectively; wherein the first and second reflective polarizers, the first and second reflectors, and the retarders are disposed to convert a second polarization state of the first and the second light beam into a first polarization state of the first and second light beams, respectively. In yet another aspect, the present disclosure provides a color combiner that includes the optical element. In yet another aspect, the present disclosure provides a display system that includes an imaging panel and the color combiner.

In yet another aspect, the present disclosure provides an optical element that includes a first color-selective dichroic filter having a first input surface, disposed to transmit a first light beam perpendicular to the first input surface, and a second color-selective dichroic filter having a second input surface, disposed to transmit a second light beam perpendicular to the second input surface. The optical element further includes a first reflective polarizer disposed to intercept the first light beam at an angle of approximately 45 degrees, and a second reflective polarizer disposed to intercept the second light beam at an angle of approximately 45 degrees. The optical element still further includes a first reflector disposed so that a line normal to the first reflector intercepts the first reflective polarizer at an angle of approximately 45 degrees, and a second reflector disposed so that a line normal to the second reflector intercepts the second reflective polarizer at an angle of approximately 45 degrees. The optical element still further includes a first and a second retarder disposed between the first and second color-selective dichroic filters, respectively, and the first reflective polarizer; and a fourth and a fifth retarder disposed between the first reflector and the first reflective polarizer, and the second reflector and the second reflective polarizer, respectively; wherein the first and second reflective polarizers, the first and second reflectors, and the retarders are disposed to convert a second polarization state of the first and the second light beam into a first polarization state of the first and second light beams, respectively. In yet another aspect, the present disclosure provides a color combiner that includes the optical element. In yet another aspect, the present disclosure provides a display system that includes an imaging panel and the color combiner.

In yet another aspect, the present disclosure provides an optical element that includes an unpolarized light beam perpendicular to a first input surface, and a first reflective polarizer disposed to intercept the unpolarized light beam at an angle of approximately 45 degrees. The optical element further includes a first reflector disposed so that a line normal to the first reflector intercepts the first reflective polarizer at an angle of approximately 45 degrees, a second reflective polarizer disposed at an angle of approximately 90 degrees to the first reflective polarizer on a side opposite the first reflector, and a second and a third reflector disposed so that a line normal to each intercepts the second reflective polarizer at an angle of approximately 45 degrees. The optical element still further includes a first, a second, and a third retarder disposed adjacent each of the first, second and third reflectors, respectively; wherein the first and second reflective polarizers and the retarders are disposed to convert a second polarization state of the unpolarized light beam into a first polarization state of the unpolarized light beam. In yet another aspect, the present disclosure provides a color combiner that includes the optical element. In yet another aspect, the present disclosure provides a display system that includes an imaging panel and the color combiner.

In yet another aspect, the present disclosure provides an optical element that includes a first color-selective dichroic filter having a first input surface, disposed to transmit a first light beam perpendicular to the first input surface, a second color-selective dichroic filter having a second input surface, disposed to transmit a second light beam perpendicular to the second input surface, and a first reflective polarizer disposed to intercept the first and the second light beam at an angle of approximately 45 degrees. The optical element further includes a first reflector disposed so that a line normal to the first reflector intercepts the first reflective polarizer at an angle of approximately 45 degrees, a second reflective polarizer disposed at an angle of approximately 90 degrees to the first reflective polarizer on a side opposite the first reflector, and a second and a third reflector disposed so that a line normal to each intercepts the second reflective polarizer at an angle of approximately 45 degrees. The optical element still further includes a first, a second, and a third retarder disposed adjacent each of the first, second and third reflectors, respectively; wherein the first and second reflective polarizers and the retarders are disposed to convert a second polarization state of the first and the second light beam into a first polarization state of the first and the second light beam, respectively. In yet another aspect, the present disclosure provides a color combiner that includes the optical element. In yet another aspect, the present disclosure provides a display system that includes an imaging panel and the color combiner.

In yet another aspect, the present disclosure provides an optical element that includes a first color-selective dichroic filter having a first input surface, disposed to transmit a first light beam perpendicular to the first input surface, a second color-selective dichroic filter having a second input surface, disposed to transmit a second light beam perpendicular to the second input surface, and a first reflective polarizer disposed to intercept the first light beam and the second light beam at an angle of approximately 45 degrees. The optical element further includes a first reflector disposed so that a line normal to the first reflector intersects the first reflective polarizer at an angle of approximately 45 degrees, a second reflective polarizer disposed to intercept a transmitted first and second light beam from the first reflective polarizer at an angle of approximately 45 degrees, and a half-wave retarder disposed between the first reflective polarizer and the second reflective polarizer. The optical element still further includes a first and a second quarter-wave retarder disposed between the first and the second color-selective dichroic filters, respectively, and the first reflective polarizer. The optical element still further includes a fourth quarter-wave retarder between the reflector and the first reflective polarizer, wherein the first and second reflective polarizers, the reflectors, and the retarders are disposed to convert a second polarization state of the first and the second light beam into a first polarization state of the first and the second light beams, respectively. In yet another aspect, the present disclosure provides a color combiner that includes the optical element. In yet another aspect, the present disclosure provides a display system that includes an imaging panel and the color combiner.

In yet another aspect, the present disclosure provides an optical element that includes a first color-selective dichroic filter having a first input surface, disposed to transmit a first light beam perpendicular to the first input surface, a second color-selective dichroic filter having a second input surface, disposed to transmit a second light beam perpendicular to the second input surface, and a first reflective polarizer disposed to intercept the first light beam at an angle of approximately 45 degrees. The optical element further includes a first reflector disposed so that a line normal to the first reflector intersects the first reflective polarizer at an angle of approximately 45 degrees, a second reflective polarizer disposed to intercept the second light beam at an angle of approximately 45 degrees, and a half-wave retarder disposed between the first reflective polarizer and the second reflective polarizer. The optical element still further includes a first and a second quarter-wave retarder disposed between the first and the second color-selective dichroic filters, respectively, and the first reflective polarizer; and a fourth quarter-wave retarder between the reflector and the first reflective polarizer, wherein the first and second reflective polarizers, the reflectors, and the retarders are disposed to convert a second polarization state of the first and the second light beam into a first polarization state of the first and the second light beams, respectively. In yet another aspect, the present disclosure provides a color combiner that includes the optical element. In yet another aspect, the present disclosure provides a display system that includes an imaging panel and the color combiner.

In yet another aspect, the present disclosure provides an optical element that includes a first color-selective dichroic filter having a first input surface, disposed to transmit a first light beam perpendicular to the first input surface, a second color-selective dichroic filter having a second input surface, disposed to transmit a second light beam perpendicular to the second input surface, and a reflective polarizer, disposed to intercept the first light beam and the second light beam at an angle of approximately 45 degrees. The optical element further includes a first reflector disposed so that a line normal to the first reflector intercepts the reflective polarizer at an angle of approximately 45 degrees, and a retarder disposed between the reflector and the reflective polarizer, wherein the reflective polarizer, the first reflector, and the retarder are disposed to convert a second polarization state of the first and second light beam into a first polarization state of the first and second light beams, respectively. In yet another aspect, the present disclosure provides a color combiner that includes the optical element. In yet another aspect, the present disclosure provides a display system that includes an imaging panel and the color combiner.

In yet another aspect, the present disclosure provides an optical element that includes a first color-selective dichroic filter having a first input surface, disposed to transmit a first light beam perpendicular to the first input surface, a second color-selective dichroic filter having a second input surface, disposed to transmit a second light beam perpendicular to the second input surface, and a reflective polarizer, disposed to intercept the first light beam and the second light beam at an angle of approximately 45 degrees. The optical element further includes a first and a second retarder disposed between the first and the second color-selective dichroic filter and the reflective polarizer, respectively; a first reflector disposed so that a line normal to the first reflector intercepts the reflective polarizer at an angle of approximately 45 degrees; and a fourth retarder disposed between the reflective polarizer and the reflector, wherein the reflective polarizer, the reflector and the retarders are disposed to combine the first and the second light beams into a combined unpolarized light beam. In yet another aspect, the present disclosure provides a color combiner that includes the optical element. In yet another aspect, the present disclosure provides a display system that includes an imaging panel and the color combiner.

In yet another aspect, the present disclosure provides an optical element that includes a first color-selective dichroic filter having a first input surface, disposed to transmit a first light beam perpendicular to the first input surface, and a reflective polarizer, disposed to intercept the first light beam at an angle of approximately 45 degrees. The optical element further includes a second color-selective dichroic filter having a second input surface disposed adjacent to the reflective polarizer, and opposite the first color-selective dichroic filter, the second color-selective dichroic filter disposed to transmit a second light beam. The optical element still further includes a first retarder disposed between the first color-selective dichroic filter and the reflective polarizer, a reflector disposed so that a line normal to the reflector intercepts the reflective polarizer at an angle of approximately 45 degrees, and a second retarder disposed between the reflective polarizer and the reflector, wherein the reflective polarizer, the reflector and the retarders are disposed to combine the first and the second light beam into a combined unpolarized light beam. In yet another aspect, the present disclosure provides a color combiner that includes the optical element. In yet another aspect, the present disclosure provides a display system that includes an imaging panel and the color combiner.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification reference is made to the appended drawings, where like reference numerals designate like elements, and wherein:

FIG. 1 is a perspective view of a polarizing beam splitter;

FIG. 2 is a perspective view of a polarizing beam splitter with a quarter-wave retarder;

FIG. 3 is a top schematic view of a polarizing beam splitter with polished faces;

FIG. 4 is a top schematic view of a color combiner;

FIG. 5 is a top schematic view of a color combiner;

FIG. 6 is a top schematic view of a color combiner;

FIG. 7 is a top schematic view of a color combiner;

FIG. 8 is a top schematic view of a color combiner;

FIG. 9 is a top schematic view of a color combiner;

FIG. 10 is a top schematic view of a color combiner;

FIG. 11 is a top schematic view of a color combiner;

FIG. 12 is a top schematic view of a color combiner; and

FIG. 13 is a schematic view of a projector.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The optical elements described herein can be configured as color combiners that receive different wavelength spectrum lights and produce a combined light output that includes the different wavelength spectrum lights. In one aspect, the received light inputs are unpolarized, and the combined light output is polarized in a desired state. In one embodiment, received lights with the undesired polarization state are recycled and rotated to the desired polarization state, improving the light utilization efficiency. In one aspect, the received light inputs are unpolarized, and the combined light output is also unpolarized. The combined light can be a polychromatic combined light that comprises more than one wavelength spectrum of light. The combined light can be a time sequenced output of each of the received lights. In one aspect, each of the different wavelength spectra of light corresponds to a different color light (e.g. red, green and blue), and the combined light output is white light, or a time sequenced red, green and blue light. For purposes of the description provided herein, “color light” and “wavelength spectrum light” are both intended to mean light having a wavelength spectrum range which may be correlated to a specific color if visible to the human eye. The more general term “wavelength spectrum light” refers to both visible and other wavelength spectrums of light including, for example, infrared light.

Also for the purposes of the description provided herein, the term “aligned to a desired polarization state” is intended to associate the alignment of the pass axis of an optical element to a desired polarization state of light that passes through the optical element, i.e., a desired polarization state such as s-polarization, p-polarization, right-circular polarization, left-circular polarization, or the like. In one embodiment described herein with reference to the Figures, an optical element such as a polarizer aligned to the first polarization state means the orientation of the polarizer that passes the p-polarization state of light, and reflects or absorbs the second polarization state (in this case the s-polarization state) of light. It is to be understood that the polarizer can instead be aligned to pass the s-polarization state of light, and reflect or absorb the p-polarization state of light, if desired.

Also for the purposes of the description provided herein, the term “facing” refers to one element disposed so that a perpendicular line from the surface of the element follows an optical path that is also perpendicular to the other element. One element facing another element can include the elements disposed adjacent each other. One element facing another element further includes the elements separated by optics so that a light ray perpendicular to one element is also perpendicular to the other element.

When two or more unpolarized color lights are directed to the optical element, each may be split according to polarization by one or more reflective polarizers. According to one embodiment described below, a color light combining system receives unpolarized light from different color unpolarized light sources, and produces a combined light output that is polarized in one desired state. In one aspect, two, three, four, or more received color lights are each split according to polarization (e.g. s-polarization and p-polarization, or right and left circular polarization) by a reflective polarizer in the optical element. The received light of one polarization state is recycled to become the desired polarization state.

According to one aspect, the optical element comprises a reflective polarizer positioned so that light from each of the three color lights intercept the reflective polarizer at approximately a 45 degree angle. The reflective polarizer can be any known reflective polarizer such as a MacNeille polarizer, a wire grid polarizer, a multilayer optical film polarizer, or a circular polarizer such as a cholesteric liquid crystal polarizer. According to one embodiment, a multilayer optical film polarizer can be a preferred reflective polarizer.

Multilayer optical film polarizers can include different “packets” of layers that serve to interact with different wavelength ranges of light. For example, a unitary multilayer optical film polarizer can include several packets of layers through the film thickness, each packet interacting with a different wavelength range (e.g. color) of light to reflect one polarization state and transmit the other polarization state. In one aspect, a multilayer optical film can have a first packet of layers adjacent a first surface of the film that interacts with, for example, blue colored light (i.e., a “blue layers”), a second packet of layers that interacts with, for example, green colored light (i.e., a “green layers”), and a third packet of layers adjacent a second surface of the film that interacts with, for example, red colored light (i.e. a “red layers”). Typically, the separation between layers in the “blue layers” is much smaller than the separation between layers in the “red layers”, in order to interact with the shorter (and higher energy) blue wavelengths of light.

Polymeric multilayer optical film polarizers can be particularly preferred reflective polarizers that can include packets of film layers as described above. Often, the higher energy wavelengths of light, such as blue light, can adversely affect the aging stability of the film, and at least for this reason it is preferable to minimize the number of interactions of blue light with the reflective polarizer. In addition, the nature of the interaction of blue light with the film affects the severity of the adverse aging. Transmission of blue light through the film is generally less detrimental to the film than reflection of blue light entering from the “blue layers” (i.e. thin layers) side. Also, reflection of blue light entering the film from the “blue layers” side is less detrimental to the film than reflection of blue light entering from the “red layers” (i.e., thick layers) side.

The reflective polarizer can be disposed between the diagonal faces of two prisms, or it can be a free-standing film such as a pellicle. In some embodiments, the optical element light utilization efficiency is improved when the reflective polarizer is disposed between two prisms, e.g. a polarizing beam splitter (PBS). In this embodiment, some of the light traveling through the PBS that would otherwise be lost from the optical path can undergo Total Internal Reflection (TIR) from the prism faces and rejoin the optical path. For at least this reason, the following description is directed to optical elements where reflective polarizers are disposed between the diagonal faces of two prisms; however, it is to be understood that the PBS can function in the same manner when used as a pellicle. In one aspect, all of the external faces of the PBS prisms are highly polished so that light entering the PBS undergoes TIR. In this manner, light is contained within the PBS and the light is partially homogenized.

According to one aspect, wavelength selective filters such as color-selective dichroic filters are placed in the path of input light from each of the different colored light sources. Each of the color-selective dichroic filters is positioned so that an input light beam intercepts the filter at near-normal incidence to minimize splitting of s- and p-polarized light, and also to minimize color shifting. Each of the color-selective dichroic filters is selected to transmit light having a wavelength spectrum of the adjacent input light source, and reflect light having a wavelength spectrum of at least one of the other input light sources. In some embodiments, each of the color-selective dichroic filters is selected to transmit light having a wavelength spectrum of the adjacent input light source, and reflect light having a wavelength spectrum of all of the other input light sources. In one aspect, each of the color-selective dichroic filters is positioned relative to the reflective polarizer so that the near-normal input light beam to the surface of each color-selective dichroic filter intersects the reflective polarizer at an intercept angle of approximately 45 degrees. By normal to the surface of a color-selective dichroic filter is meant a line passing perpendicular to the surface the color-selective dichroic filter; by near-normal is meant varying less than about 20 degrees from normal, or preferably less than about 10 degrees from normal. In one embodiment, the intercept angle with the reflective polarizer ranges from about 25 to 65 degrees; from 35 to 55 degrees; from 40 to 50 degrees; from 43 to 47 degrees; or from 44.5 to 45.5 degrees. In one aspect, input light of an undesired polarization state is converted to the desired polarization state by being directed toward a retarder and a color-selective dichroic filter where it reflects and changes polarization state by passing through the retarder twice. In one embodiment, a retarder is disposed within the light path from each input light to the prism face, so that light from one light source passes through a color-selective dichroic filter and a retarder before entering the PBS prism face. Light having an undesired polarization state is converted by passing through at least a second retarder twice, before and after reflection from at least a second color-selective dichroic filter, changing to the desired polarization state.

In one embodiment, the retarder is placed between the color-selective dichroic filter and the reflective polarizer. The particular combination of color-selective dichroic filters, retarders, and source orientation all cooperate to enable a smaller, more compact, optical element that, when configured as a color combiner, efficiently produces combined light of a single polarization state. According to one aspect, the retarder is a quarter-wave retarder aligned at approximately 45 degrees to a polarization state of the reflective polarizer. In one embodiment, the alignment can be from 35 to 55 degrees; from 40 to 50 degrees; from 43 to 47 degrees; or from 44.5 to 45.5 degrees to a polarization state of the reflective polarizer.

In one aspect, the first color light comprises an unpolarized blue light, the second color light comprises an unpolarized green light and the third color light comprises an unpolarized red light, and the color light combiner combines the red light, blue light and green light to produce polarized white light. In one aspect, the first color light comprises an unpolarized blue light, the second color light comprises an unpolarized green light and the third color light comprises an unpolarized red light, and the color light combiner combines the red, green and blue light to produce a time sequenced polarized red, green and blue light. In one aspect, each of the first, second and third color lights are disposed in separate light sources. In another aspect, more than one of the three color lights is combined into one of the sources. In yet another aspect, more than three color lights are combined in the optical element to produce a combined light.

According to one aspect, the reflective polarizing film comprises a multi-layer optical film. In one embodiment, the PBS produces a first combined light output that includes p-polarized second color light, and s-polarized first and third color light. In another embodiment, the PBS produces a p-polarized first and third color light, and an s-polarized second color light. The first combined light output can be passed through a color-selective stacked retardation filter that selectively changes the polarization of the second color light as the second color light passes through the filter. Such color-selective stacked retardation filters are available from, for example, ColorLink Inc, Boulder, Colo. The filter produces a second combined light output that includes the first, second and third color lights combined to have the same polarization (e.g. s-polarization). The second combined output is useful for illumination of transmissive or reflective display mechanisms that modulate polarized light to produce an image.

The light beam includes light rays that can be collimated, convergent, or divergent when it enters the PBS. Convergent or divergent light entering the PBS can be lost through one of the faces or ends of the PBS. To avoid such losses, all of the exterior faces of a prism based PBS can be polished to enable total internal reflection (TIR) within the PBS. Enabling TIR improves the utilization of light entering the PBS, so that substantially all of the light entering the PBS within a range of angles is redirected to exit the PBS through the desired face.

A polarization component of each color light can pass through to a polarization rotating reflector. The polarization rotating reflector deflects the propagation direction of the light and alters the magnitude of the polarization components, depending of the type and orientation of a retarder disposed in the polarization rotating reflector. The polarization rotating reflector can include a wavelength-selective mirror, such as a color-selective dichroic filter, and a retarder. The retarder can provide any desired retardation, such as an eighth-wave retarder, a quarter-wave retarder, and the like. In embodiments described herein, there is an advantage to using a quarter-wave retarder and an associated dichroic reflector. Linearly polarized light is changed to circularly polarized light as it passes through a quarter-wave retarder aligned at an angle of 45° to the axis of light polarization. Subsequent reflections from the reflective polarizer and quarter-wave retarder/reflectors in the color combiner result in efficient combined light output from the color combiner. In contrast, linearly polarized light is changed to a polarization state partway between s-polarization and p-polarization (either elliptical or linear) as it passes through other retarders and orientations, and can result in a lower efficiency of the combiner. Polarization rotating reflectors generally comprise a color-selective dichroic filter and retarder. The position of the retarder and color-selective dichroic filter relative to the adjacent light source is dependent on the desired path of each of the polarization components, and are described elsewhere with reference to the Figures. In one aspect, the reflective polarizer can be a circular polarizer such as a cholesteric liquid crystal polarizer. According to this aspect, polarization rotating reflectors can comprise color-selective dichroic filters without any associated retarders.

The components of the optical element including prisms, reflective polarizers, quarter-wave retarders, mirrors, filters or other components can be bonded together by a suitable optical adhesive. The optical adhesive used to bond the components together has an index of refraction less than or equal to the index of refraction of the prisms used in the optical element. An optical element that is fully bonded together offers advantages including alignment stability during assembly, handling and use. In some embodiments, two adjacent prisms can be bonded together using an optical adhesive. In some embodiments, a unitary optical component can incorporate the optics of the two adjacent prisms; e.g., such as a single triangular prism which incorporates the optics of two adjacent triangular prisms, as described elsewhere.

The embodiments described above can be more readily understood by reference to the Figures and their accompanying description, which follows.

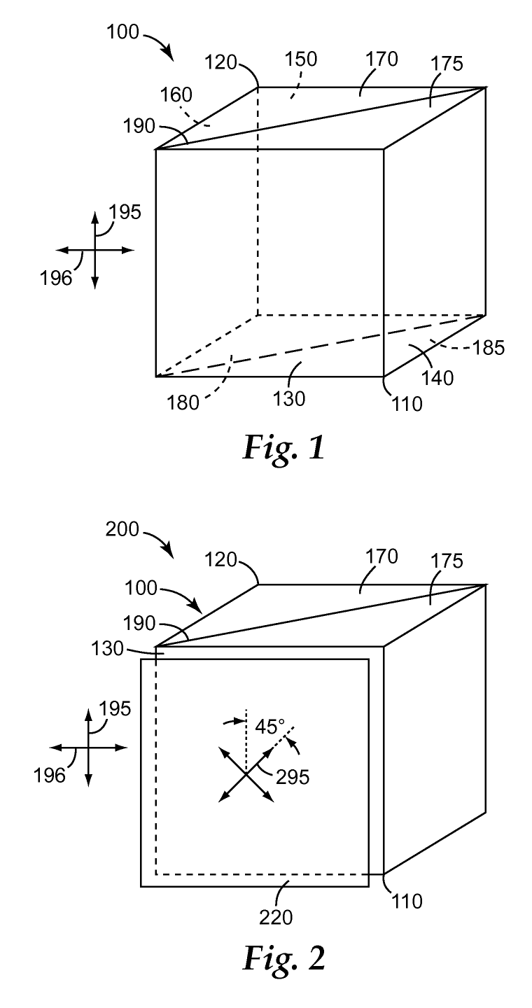

FIG. 1 is a perspective view of a PBS. PBS 100 includes a reflective polarizer 190 disposed between the diagonal faces of prisms 110 and 120. Prism 110 includes two end faces 175, 185, and a first and second prism face 130, 140 having a 90° angle between them. Prism 120 includes two end faces 170, 180, and a third and fourth prism face 150, 160 having a 90° angle between them. The first prism face 130 is parallel to the third prism face 150, and the second prism face 140 is parallel to the fourth prism face 160. The identification of the four prism faces shown in FIG. 1 with a “first”, “second”, “third” and “fourth” serves only to clarify the description of PBS 100 in the discussion that follows. First reflective polarizer 190 can be a Cartesian reflective polarizer or a non-Cartesian reflective polarizer. A non-Cartesian reflective polarizer can include multilayer inorganic films such as those produced by sequential deposition of inorganic dielectrics, such as a MacNeille polarizer. A Cartesian reflective polarizer has a polarization axis state, and includes both wire-grid polarizers and polymeric multilayer optical films such as can be produced by extrusion and subsequent stretching of a multilayer polymeric laminate. In one embodiment, reflective polarizer 190 is aligned so that one polarization axis is parallel to a first polarization state 195, and perpendicular to a second polarization state 196. In one embodiment, the first polarization state 195 can be the s-polarization state, and the second polarization state 196 can be the p-polarization state. In another embodiment, the first polarization state 195 can be the p-polarization state, and the second polarization state 196 can be the s-polarization state. As shown in FIG. 1, the first polarization state 195 is perpendicular to each of the end faces 170, 175, 180, 185.

A Cartesian reflective polarizer film provides the polarizing beam splitter with an ability to pass input light rays that are not fully collimated, and that are divergent or skewed from a central light beam axis, with high efficiency. The Cartesian reflective polarizer film can comprise a polymeric multilayer optical film that comprises multiple layers of dielectric or polymeric material. Use of dielectric films can have the advantage of low attenuation of light and high efficiency in passing light. The multilayer optical film can comprise polymeric multilayer optical films such as those described in U.S. Pat. No. 5,962,114 (Jonza et al.) or U.S. Pat. No. 6,721,096 (Bruzzone et al.).

FIG. 2 is a perspective view of the alignment of a quarter-wave retarder to a PBS, as used in some embodiments. Quarter-wave retarders can be used to change the polarization state of incident light. PBS retarder system 200 includes PBS 100 having first and second prisms 110 and 120. A quarter-wave retarder 220 is disposed adjacent the first prism face 130. Reflective polarizer 190 is, for example, a Cartesian reflective polarizer film aligned to first polarization state 195. Quarter-wave retarder 220 includes a quarter-wave polarization state 295 that can be aligned at 45° to first polarization state 195. Although FIG. 2 shows polarization state 295 aligned at 45° to first polarization state 195 in a clockwise direction, polarization state 295 can instead be aligned at 45° to first polarization state 195 in a counterclockwise direction. In some embodiments, quarter-wave polarization state 295 can be aligned at any degree orientation to first polarization state 195, for example from 90° in a counter-clockwise direction to 90° in a clockwise direction. It can be advantageous to orient the retarder at approximately +/−45° as described, since circularly polarized light results when linearly polarized light passes through a quarter-wave retarder so aligned to the polarization state. Other orientations of quarter-wave retarders can result in s-polarized light not being fully transformed to p-polarized light, and p-polarized light not being fully transformed to s-polarized light upon reflection from the mirrors, resulting in reduced efficiency of the optical elements described elsewhere in this description.

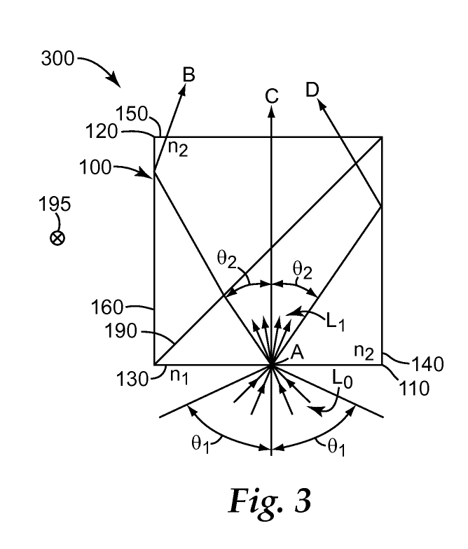

FIG. 3 shows a top view of a path of light rays within a polished PBS 300. According to one embodiment, the first, second, third and fourth prism faces 130, 140, 150, 160 of prisms 110 and 120 are polished external surfaces. According to another embodiment, all of the external faces of the PBS 100 (including end faces, not shown) are polished faces that provide TIR of oblique light rays within polished PBS 300. The polished external surfaces are in contact with a material having an index of refraction “n₁” that is less than the index of refraction “n₂” of prisms 110 and 120. TIR improves light utilization in polished PBS 300, particularly when the light directed into polished PBS 300 is not collimated along a central axis, i.e. the incoming light is either convergent or divergent. At least some light is trapped in polished PBS 300 by total internal reflections until it leaves through third prism face 150. In some cases, substantially all of the light is trapped in polished PBS 300 by total internal reflections until it leaves through third prism face 150.

As shown in FIG. 3, light rays L₀ enter first prism face 130 within a range of angles θ₁. Light rays L₁ within polished PBS 300 propagate within a range of angles θ₂ such that the TIR condition is satisfied at prism faces 140, 160 and the end faces (not shown). Light rays “AB”, “AC” and “AD” represent three of the many paths of light through polished PBS 300, that intersect reflective polarizer 190 at different angles of incidence before exiting through third prism face 150. Light rays “AB” and “AD” also both undergo TIR at prism faces 160 and 140, respectively, before exiting. It is to be understood that ranges of angles θ₁ and θ₂ can be a cone of angles so that reflections can also occur at the end faces of polished PBS 300. In one embodiment, reflective polarizer 190 is selected to efficiently split light of different polarizations over a wide range of angles of incidence. A polymeric multilayer optical film is particularly well suited for splitting light over a wide range of angles of incidence. Other reflective polarizers including MacNeille polarizers and wire-grid polarizers can be used, but are less efficient at splitting the polarized light. A MacNeille polarizer does not efficiently transmit light at angles of incidence that differ substantially from the design angle, which is typically 45 degrees to the polarization selective surface, or normal to the input face of the PBS. Efficient splitting of polarized light using a MacNeille polarizer can be limited to incidence angles below about 6 or 7 degrees from the normal, since significant reflection of the p-polarization state can occur at some larger angles, and significant transmission of s-polarization state can also occur at some larger angles. Both effects can reduce the splitting efficiency of a MacNeille polarizer. Efficient splitting of polarized light using a wire-grid polarizer typically requires an air gap adjacent one side of the wires, and efficiency drops when a wire-grid polarizer is immersed in a higher index medium. A wire-grid polarizer used for splitting polarized light is shown, for example, in PCT publication WO 2008/1002541.

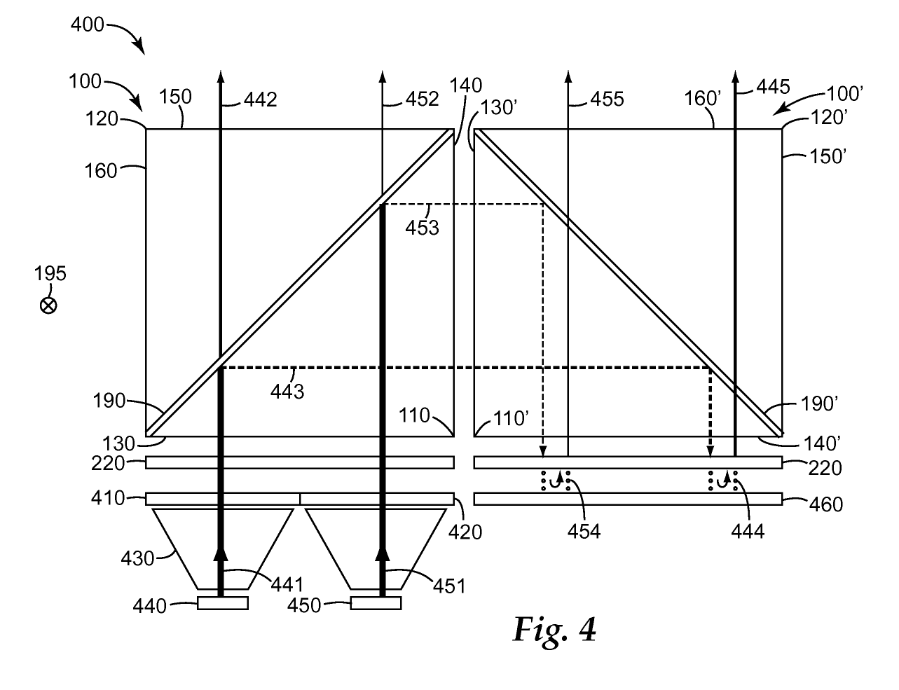

In one aspect, FIG. 4 is a top view schematic view of an optical element configured as a color combiner 400 that includes a first PBS 100 and a second PBS 100′. Color combiner 400 can be used with a variety of light sources as described elsewhere. The paths of light rays of each polarization state emitted from a first and a second light source 440, 450 are shown in FIG. 4, to more clearly illustrate the function of the various components of color combiner 400. First PBS 100 includes a reflective polarizer 190 aligned to the first polarization state 195, disposed between the diagonal faces of first and second prisms 110, 120, as described elsewhere. Second PBS 100′ includes a reflective polarizer 190′ aligned to the first polarization state 195, disposed between the diagonal faces of first and second prisms 110′, 120′, as described elsewhere. A reflector 460 is disposed adjacent prism face 140′, and a retarder 220 is disposed between the reflector 460 and the reflective polarizer 190′.

A first and second wavelength-selective filter 410, 420 are disposed facing the first prism face 130. Each of the first and second wavelength-selective filters 410, 420 can be a color-selective dichroic filter selected to transmit a first and second wavelength spectrum of light, respectively, and reflect other wavelength spectrums of light. In one aspect, the reflective polarizer 190 can comprise a polymeric multilayer optical film. In one embodiment, reflective polarizer 190 includes blue layers disposed proximate first and second color-selective dichroic filters 410, 420, as described elsewhere.

A retarder 220 is disposed facing each of the first and second color-selective dichroic filters 410, 420. The retarders 220, color-selective dichroic filter (410, 420), reflective polarizers (190, 190′), and reflector 460 cooperate to transmit one polarization state of light through the third and fourth prism faces (150, 160′) of the first and second PBS (100, 100′), respectively, and recycle the other polarization state of light, as described elsewhere. In one embodiment described below, each retarder 220 in color combiner 400 is a quarter-wave retarder orientated at approximately 45 degrees to the first polarization state 195.

According to another aspect, an optional light tunnel 430 or assemblies of lenses (not shown) can be provided for each of the first and second light sources 440, 450, to provide spacing that separates the light sources from the polarizing beam splitter, as well as provide for some collimation of light. Light tunnels could have straight or curved sides, or they could be replaced by a lens system. Different approaches may be preferred depending on specific details of each application, and those with skill in the art will face no difficulty in selecting the optimal approach for a specific application.

An optional integrator (not shown) can be provided at the output (third and fourth prism faces 150, 160′) of color combiner 400, or any color combiner described herein, to increase uniformity of combined light outputs. According to one aspect, each light source (440, 450) comprises one or more light emitting diodes (LED's). Various light sources can be used such as lasers, laser diodes, organic LED's (OLED's), and non solid state light sources such as ultra high pressure (UHP), halogen or xenon lamps with appropriate collectors or reflectors. Light sources, light tunnels, lenses, and light integrators useful in the present invention are further described, for example, in Published U.S. Patent Application No. US 2008/0285129, the disclosure of which is herein included in its entirety.

The path of a first color light 441 will now be described with reference to FIG. 4, where unpolarized first color light 441 exits third prism face 150 of first PBS 100 as p-polarized first color light 442 and fourth prism face 160′ of second PBS 10′ as p-polarized first color light 445.

First light source 440 injects unpolarized first color light 441 through first color-selective dichroic filter 410, quarter-wave retarder 220, enters first PBS 100 through first prism face 130, intercepts reflective polarizer 190, and is split into p-polarized first color light 442 and s-polarized first color light 443. P-polarized first color light 442 passes through reflective polarizer 190, exits first PBS 100 through third prism face 150 as p-polarized first color light 442.

S-polarized first color light 443 reflects from reflective polarizer 190, exits first PBS 100 through second prism face 140, enters second PBS 100′ through first prism face 130′, and reflects from reflective polarizer 190′. S-polarized first color light 443 then exits second PBS 100′ through second prism face 140′and changes to circularly polarized light 444 as it passes through quarter-wave retarder 220. Circularly polarized light 444 reflects from reflector 460, changing state of circular polarization, and changes to p-polarized first color light 445 as it passes through quarter-wave retarder 220. P-polarized first color light 445 enters second PBS 100′ through second prism face 140′, passes unchanged through reflective polarizer 190′, and exits second PBS 100′ through fourth prism face 160′ as p-polarized first color light 445.

The path of a second color light 451 will now be described with reference to FIG. 4, where unpolarized second color light 451 exits third prism face 150 of first PBS 100 as p-polarized second color light 452 and fourth prism face 160′ of second PBS 100′ as p-polarized second color light 455.

Unpolarized second color light 451 from second light source 450 passes through second color-selective dichroic filter 420, quarter-wave retarder 220, enters first PBS 100 through first prism face 130, intercepts reflective polarizer 190, and is split into p-polarized second color light 452 and s-polarized second color light 453. P-polarized second color light 452 passes through reflective polarizer 190, and exits first PBS 100 through third prism face 150 as p-polarized second color light 452.

S-polarized second color light 453 reflects from reflective polarizer 190, exits first PBS 100 through second prism face 140, enters second PBS 100′ through first prism face 130′, and reflects from reflective polarizer 190′. S-polarized second color light 453 then exits second PBS 100′ through second prism face 140′ and changes to circularly polarized light 454 as it passes through quarter-wave retarder 220. Circularly polarized light 454 reflects from reflector 460, changing state of circular polarization, and changes to p-polarized second color light 455 as it passes through quarter-wave retarder 220. P-polarized second color light 455 enters second PBS 100′ through second prism face 140′, passes unchanged through reflective polarizer 190′, and exits second PBS 100′ through fourth prism face 160′ as p-polarized second color light 445.

In one embodiment, first color light 441 is green light and second color light 451 is magenta light. According to this embodiment, first color-selective dichroic filter 410 is a red and blue (i.e., magenta) light reflecting and green light transmitting dichroic filter; second color-selective dichroic filter 420 is a green light reflecting and magenta light transmitting dichroic filter. According to this embodiment, the first polarization state of the blue component of second color light 451 is transmitted once and the second polarization state of the blue component of second color light 451 is reflected once by each reflective polarizer 190, 190′. The single reflection is preferably a front surface reflection from the blue layers, which results from orientation of the reflective polarizer 190, as described elsewhere.

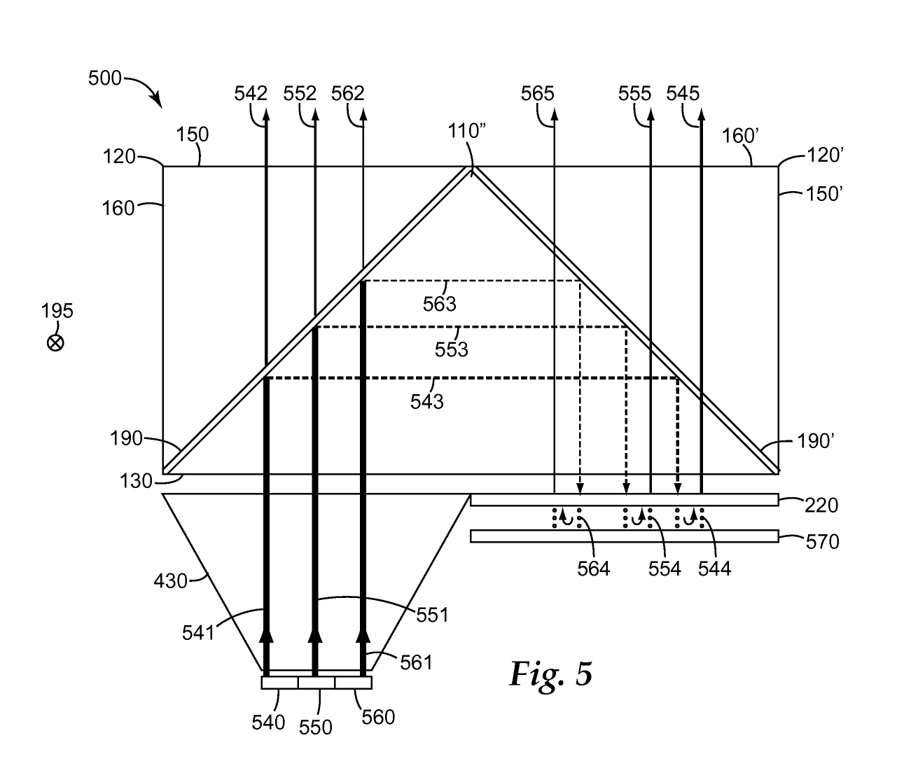

In one aspect, FIG. 5 is a top schematic view of an optical element configured as a color combiner 500, which functions in a manner similar to the color combiner 400 shown in FIG. 4. In FIG. 5, the first and third prisms (110, 110′) of the first PBS 100 and the second PBS 100′ of color combiner 400 of FIG. 4 have been combined into a single unitary prism 110″. Color combiner 500 can be used with a variety of light sources as described elsewhere. The paths of light rays of each polarization emitted from a first, a second, and a third light source (540, 550, 560) are shown in FIG. 5, to more clearly illustrate the function of the various components of color combiner 500. Color combiner 500 includes a first and second reflective polarizer (190, 190′) aligned to the first polarization state 195, disposed between the diagonal faces of second and fourth prisms (120, 120′) and unitary prism 110″, as described elsewhere.

In one aspect, the first and second reflective polarizers 190, 190′ can comprise a polymeric multilayer optical film. In one embodiment, first reflective polarizer 190 includes blue layers disposed proximate the first, the second, and the third light sources (540, 550, 560), and second reflective polarizer 190′ includes blue layers disposed proximate first reflective polarizer 190′, as described elsewhere.

A retarder 220 is disposed between a reflector 570 and the second reflective polarizer 190′. The retarder 220, the reflector 570, and first and second reflective polarizer 190, 190′ cooperate to transmit one polarization state of light through the third prism face 150 and the fourth prism face 160′, and recycle the other polarization state of light, as described elsewhere. In one embodiment described below, the retarder 220 in color combiner 500 is a quarter-wave retarder orientated at approximately 45 degrees to the first polarization state 195.

According to another aspect, an optional light tunnel 430 or assemblies of lenses (not shown) can be provided for each of the first, second, and third light sources (540, 550, 560) as described elsewhere with reference to FIG. 4, the disclosure of which applies equally to FIG. 5. In some cases, the first, second, and third light sources (540, 550, 560) can be separate colored LED light sources as described elsewhere, and can include either separate (not shown) or combined light tunnel 430. In some cases, the first, second, and third light sources (540, 550, 560) can instead be a combined color light source (not shown), such as a white light.

The path of a first color light 541 will now be described with reference to FIG. 5, where unpolarized first color light 541 exits third prism face 150 as p-polarized first color light 542 and fourth prism face 160′ as p-polarized first color light 545.

Unpolarized first color light 541 from first light source 540 enters first prism face 130, intercepts first reflective polarizer 190, and is split into p-polarized first color light 542 and s-polarized first color light 543. P-polarized first color light 542 passes through first reflective polarizer 190, and exits through third prism face 150 as p-polarized first color light 542.

S-polarized first color light 543 reflects from first reflective polarizer 190, reflects from second reflective polarizer 190′, and exits through first prism face 130. S-polarized first color light 543 changes to circularly polarized light 544 as it passes through quarter-wave retarder 220, reflects from reflector 570, changing state of circular polarization, and changes to p-polarized first color light 545 as it passes through quarter-wave retarder 220. P-polarized first color light 545 enters through first prism face 130, passes through second reflective polarizer 190′, and exits through fourth prism face 160′ as p-polarized first color light 545.

The paths of a second color light 551 and a third color light 561 can be seen in FIG. 5 to be identical to the path of the first color light 541 described above. Thus, unpolarized second color light 551 exits fourth prism face 160′ as p-polarized second color light 555 and third prism face 150 as p-polarized second color light 552. Also, unpolarized third color light 561 exits fourth prism face 160′ as p-polarized third color light 565 and third prism face 150 as p-polarized second color light 562.

Unpolarized second color light 551 from second light source 550 enters first prism face 130, intercepts first reflective polarizer 190, and is split into p-polarized second color light 552 and s-polarized second color light 553. P-polarized second color light 552 passes through first reflective polarizer 190, and exits through third prism face 150 as p-polarized second color light 552.

S-polarized second color light 553 reflects from first reflective polarizer 190, reflects from second reflective polarizer 190′, and exits through first prism face 130. S-polarized second color light 553 changes to circularly polarized light 554 as it passes through quarter-wave retarder 220, reflects from reflector 570, changing state of circular polarization, and changes to p-polarized second color light 555 as it passes through quarter-wave retarder 220. P-polarized second color light 555 enters through first prism face 130, passes through second reflective polarizer 190′, and exits through fourth prism face 160′ as p-polarized second color light 555.

Unpolarized third color light 561 from third light source 560 enters first prism face 130, intercepts first reflective polarizer 190, and is split into p-polarized third color light 562 and s-polarized third color light 563. P-polarized third color light 562 passes through first reflective polarizer 190, and exits through third prism face 150 as p-polarized third color light 562.

S-polarized third color light 563 reflects from first reflective polarizer 190, reflects from second reflective polarizer 190′, and exits through first prism face 130. S-polarized third color light 563 changes to circularly polarized light 564 as it passes through quarter-wave retarder 220, reflects from reflector 570, changing state of circular polarization, and changes to p-polarized third color light 565 as it passes through quarter-wave retarder 220. P-polarized third color light 565 enters through first prism face 130, passes through second reflective polarizer 190′, and exits through fourth prism face 160′ as p-polarized third color light 565.

In one embodiment, first color light 541 is red light, second color light 551 is green light and third color light 561 is magenta light. According to this embodiment, the first polarization state of the blue component of third color light 551 is transmitted once and the second polarization state of the blue component of second color light 551 is reflected once by each of the reflective polarizers 190, 190′. The single reflection is preferably a front surface reflection from the blue layers, which results from orientation of the reflective polarizers 190, 190′, as described elsewhere. In some cases, the first, second, and third light sources (540, 550, 560) are a combined color light source (not shown), such as a white light.

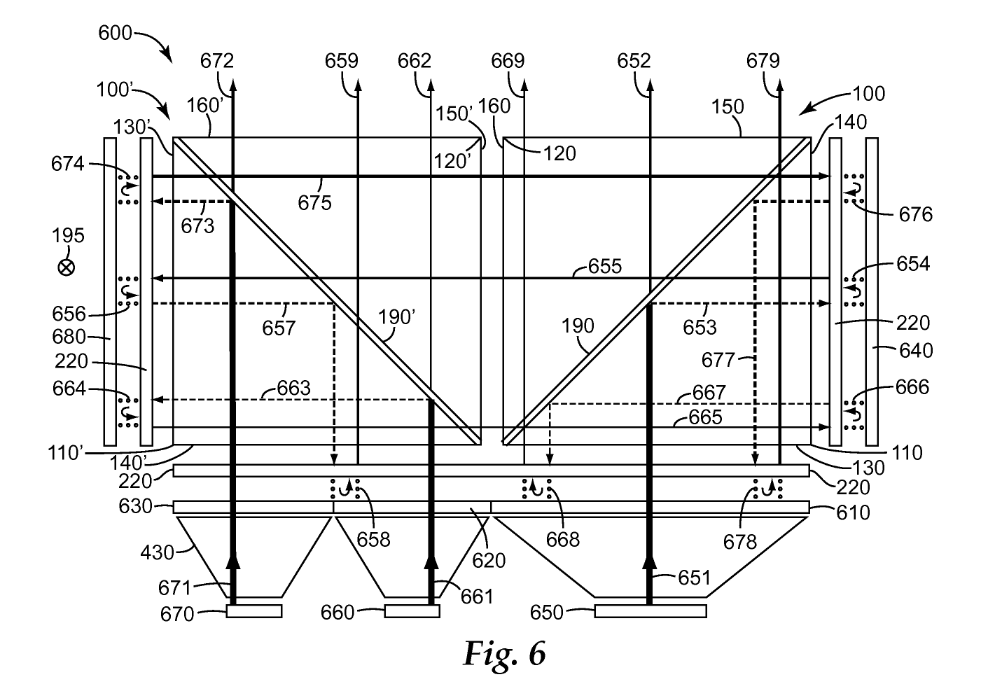

In one aspect, FIG. 6 is a top view schematic representation of an optical element configured as a color combiner 600 that includes a first PBS 100 and a second PBS 100′. Color combiner 600 can be used with a variety of light sources as described elsewhere. The paths of light rays of each polarization emitted from a first, a second and a third light source 650, 660, 670 are shown in FIG. 6, to more clearly illustrate the function of the various components of color combiner 600. First PBS 100 and second PBS 100′ include a first and second reflective polarizer 190, 190′ aligned to the first polarization state 195, disposed between the diagonal faces of first and second prisms 110, 120 and 110′, 120′, as described elsewhere. In one embodiment, second prism 120′ of second PBS 100′ and second prism 120 of first PBS 100 can be a unitary optical component (not shown), such as a prism having three sides bounded by second reflective polarizer 190′, first reflective polarizer 190, and fourth prism face 160′ and third prism face 150.

A first wavelength selective filter 610 is disposed facing the first prism face 130 of first PBS 100. A second and a third wavelength selective filter (620, 630) is disposed facing the second prism face 140′ of second PBS 100′. Each of the first, second and third wavelength selective filters 610, 620, 630 can be a color-selective dichroic filter selected to transmit a first, second and third wavelength spectrum of light, respectively, and reflect other wavelength spectrums of light. In one aspect, the first and second reflective polarizers 190, 190′ can comprise a polymeric multilayer optical film. In one embodiment, first reflective polarizer 190 includes blue layers disposed proximate first color-selective dichroic filter 610, and second reflective polarizer 190′ includes blue layers disposed proximate both second color-selective dichroic filter 620 and third color-selective dichroic filter 630, as described elsewhere.

A polarization rotating reflector comprising a broadband mirror 640 is disposed facing the second prism face 140 of first PBS 100. The polarization rotating reflector further comprises a retarder 220 disposed between second prism face 140 and broadband mirror 640. Broadband mirror 640 and retarder 220 serve to convert polarization states of light leaving first PBS 100 through second prism face 140, and redirect the converted polarization state light back into first PBS 100, as described elsewhere.

A polarization rotating reflector comprising a broadband mirror 680 is disposed facing the first prism face 130′ of second PBS 100′. The polarization rotating reflector further comprises a retarder 220 disposed between first prism face 130′ and broadband mirror 680. Broadband mirror 680 and retarder 220 serve to convert polarization states of light leaving second PBS 100′ through first prism face 130′, and redirect the converted polarization state light back into second PBS 100′, as described elsewhere.

A retarder 220 is disposed facing each of the first, second and third color-selective filters (610, 620, 630). In some cases, as shown in FIG. 6, the retarder 220 can be a unitary retarder 220 that spans first prism face 130 of first PBS 100, and second prism face 140′ of second PBS 100′. In some cases, a separate retarder 220 can be disposed adjacent each color- selective filter (610, 620, 630). The retarder 220, color-selective filter (610, 620, 630), reflector (640, 680), and first and second reflective polarizer 190, 190′ cooperate to transmit one polarization state of light through the third prism face 150 of first PBS 100 and the fourth prism face 160′ of second PBS 100′, and recycle the other polarization state of light, as described elsewhere. In one embodiment described below, each retarder 220 in color combiner 600 is a quarter-wave retarder orientated at approximately 45 degrees to the first polarization state 195.

According to another aspect, an optional light tunnel 430 or assemblies of lenses (not shown) can be provided for each of the first, second and third light sources 650, 660, 670, as described elsewhere with reference to FIG. 4, the disclosure of which applies equally to FIG. 6.

The path of a first color light 651 will now be described with reference to FIG. 6, where unpolarized first color light 651 exits third prism face 150 of first PBS 100 as p-polarized first color light 652 and fourth prism face 160′ of second PBS 100′ as p-polarized first color light 659.

Unpolarized first color light 651 from first light source 650 passes through first color-selective dichroic filter 610, quarter-wave retarder 220, enters first PBS 100 through first prism face 130, intercepts first reflective polarizer 190, and is split into p-polarized first color light 652 and s-polarized first color light 653. P-polarized first color light 652 passes through first reflective polarizer 190, and exits first PBS 100 through third prism face 150 as p-polarized first color light 652.

S-polarized first color light 653 reflects from first reflective polarizer 190, exits first PBS 100 through second prism face 140, changes to circularly polarized light 654 as it passes through quarter-wave retarder 220, reflects from broadband mirror 640 changing state of circular polarization, and changes to p-polarized first color light 655 as it passes through quarter-wave retarder 220. P-polarized first color light 655 enters first PBS 100 through second prism face 140, passes through first reflective polarizer 190, exits first PBS 100 through fourth prism face 160, enters second PBS 100′ through third prism face 150′, passes through second reflective polarizer 190′, and exits second PBS 100′ through first prism face 130′. P-polarized first color light 655 changes to circularly polarized light 656 as it passes through quarter-wave retarder 220, reflects from broadband mirror 680 changing state of circular polarization, changes to s-polarized first color light 657 as it passes through quarter-wave retarder 220, enters second PBS 100′ through first prism face 130′, reflects from second reflective polarizer 190′, and exits second PBS 100′ through second prism face 140′. S-polarized first color light 657 changes to circularly polarized light 658 as it passes through quarter-wave retarder 220, reflects from either second color-selective dichroic filter 620 or third color-selective dichroic filter 630 changing state of circular polarization, becomes p-polarized first color light 659 as it passes through quarter-wave retarder 220, enters second PBS 100′ through second prism face 140′, passes through second reflective polarizer 190′, and exits second PBS 100′ through fourth prism face 160′ as p-polarized first color light 659.

The path of a second color light 661 will now be described with reference to FIG. 6, where unpolarized second color light 661 exits third prism face 150 of first PBS 100 as p-polarized second color light 669 and fourth prism face 160′ of second PBS 100′ as p-polarized second color light 662.

Unpolarized second color light 661 from second light source 660 passes through second color-selective dichroic filter 620, quarter-wave retarder 220, enters second PBS 100′ through second prism face 140′, intercepts second reflective polarizer 190′, and is split into p-polarized second color light 662 and s-polarized second color light 663. P-polarized second color light 662 passes through second reflective polarizer 190′, and exits second PBS 100′ through fourth prism face 160′ as p-polarized second color light 662.

S-polarized second color light 663 reflects from second reflective polarizer 190′, exits second PBS 100′ through first prism face 130′, changes to circularly polarized light 664 as it passes through quarter-wave retarder 220, reflects from broadband mirror 680 changing state of circular polarization, changes to p-polarized second color light 665 as it passes through quarter-wave retarder 220, enters second PBS 100′ through first prism face 130′, passes through second reflective polarizer 190′, and exits second PBS 100′ through third prism face 150′. P-polarized second color light 665 enters first PBS 100 through fourth prism face 160, passes through first reflective polarizer 190, exits first PBS 100 through second prism face 140, and changes to circularly polarized light 666 as it passes through quarter-wave retarder 220. Circularly polarized light 666 reflects from broadband mirror 640 changing state of circular polarization, changes to s-polarized second color light 667 as it passes through quarter-wave retarder 220, enters first PBS 100 through second prism face 140, reflects from first reflective polarizer 190, and exits first PBS 100 through first prism face 130. S-polarized second color light 667 changes to circularly polarized light 668 as it passes through quarter-wave retarder 220, reflects from first color-selective dichroic filter 610 changing state of circular polarization, changes to p-polarized second color light 669 as it passes through quarter-wave retarder 220 and enters first PBS 100 through first prism face 130. P-polarized second color light 669 passes through first reflective polarizer 190, and exits first PBS 100 through third prism face 150 as p-polarized second color light 669.

The path of a third color light 671 will now be described with reference to FIG. 6, where unpolarized third color light 671 exits third prism face 150 of first PBS 100 as p-polarized third color light 679 and fourth prism face 160′ of second PBS 100′ as p-polarized third color light 675. It will be appreciated that the paths of third color light 671 and second color light 661 through color combiner 600 are similar, as seen in FIG. 6.

Unpolarized third color light 671 from second light source 670 passes through third color-selective dichroic filter 630, quarter-wave retarder 220, enters second PBS 100′ through second prism face 140′, intercepts second reflective polarizer 190′, and is split into p-polarized third color light 672 and s-polarized third color light 673. P-polarized third color light 672 passes through second reflective polarizer 190′, and exits second PBS 100′ through fourth prism face 160′ as p-polarized third color light 672.

S-polarized third color light 673 reflects from second reflective polarizer 190′, exits second PBS 100′ through first prism face 130′, changes to circularly polarized light 674 as it passes through quarter-wave retarder 220, reflects from broadband mirror 680 changing state of circular polarization, changes to p-polarized third color light 675 as it passes through quarter-wave retarder 220, enters second PBS 100′ through first prism face 130′, passes through second reflective polarizer 190′, and exits second PBS 100′ through third prism face 150′. P-polarized third color light 675 enters first PBS 100 through fourth prism face 160, passes through first reflective polarizer 190, exits first PBS 100 through second prism face 140, and changes to circularly polarized light 676 as it passes through quarter-wave retarder 220. Circularly polarized light 676 reflects from broadband mirror 640 changing state of circular polarization, changes to s-polarized third color light 677 as it passes through quarter-wave retarder 220, enters first PBS 100 through second prism face 140, reflects from first reflective polarizer 190, and exits first PBS 100 through first prism face 130. S-polarized third color light 677 changes to circularly polarized light 678 as it passes through quarter-wave retarder 220, reflects from first color-selective dichroic filter 610 changing state of circular polarization, changes to p-polarized third color light 679 as it passes through quarter-wave retarder 220 and enters first PBS 100 through first prism face 130. P-polarized third color light 679 passes through first reflective polarizer 190, and exits first PBS 100 through third prism face 150 as p-polarized third color light 679.

In one embodiment, first color light 651 is green light, second color light 661 is blue light, and third color light 671 is red light. According to this embodiment, first color-selective dichroic filter 610 is a red and blue light reflecting and green light transmitting dichroic filter; second color-selective dichroic filter 620 is a green and red light reflecting and blue light transmitting dichroic filter; third color-selective dichroic filter 630 is a blue and green light reflecting and red light transmitting dichroic filter. According to this embodiment, the first polarization state of the blue second color light 661 is transmitted twice through each of the reflective polarizers 190, 190′, and the second polarization state of the blue second color light 661 is reflected once by each of the reflective polarizers 190, 190′. The single reflection is preferably a front surface reflection from the blue layers, which results from orientation of the reflective polarizers 190, 190′, as described elsewhere.

In one embodiment, a fourth color light (not shown) can also be injected into the color combiner 600. In this embodiment, the polarization rotating reflector comprises a fourth color-selective dichroic filter that replaces the broadband mirror 640 described above, an optional light tunnel, and a fourth light source arranged in a manner similar to the first, second and third 650, 660, 670 light sources, optional light tunnels 430, and color-selective dichroic filters 610, 620, 630 shown in FIG. 6. Fourth color-selective dichroic filter reflects first, second and third color lights 651, 661, 671, and transmits fourth color light (not shown). In this embodiment, fourth color light also passes through third prism face 150 of first PBS 100 and fourth prism face 160′ of second PBS 100′ in the p-polarization state.

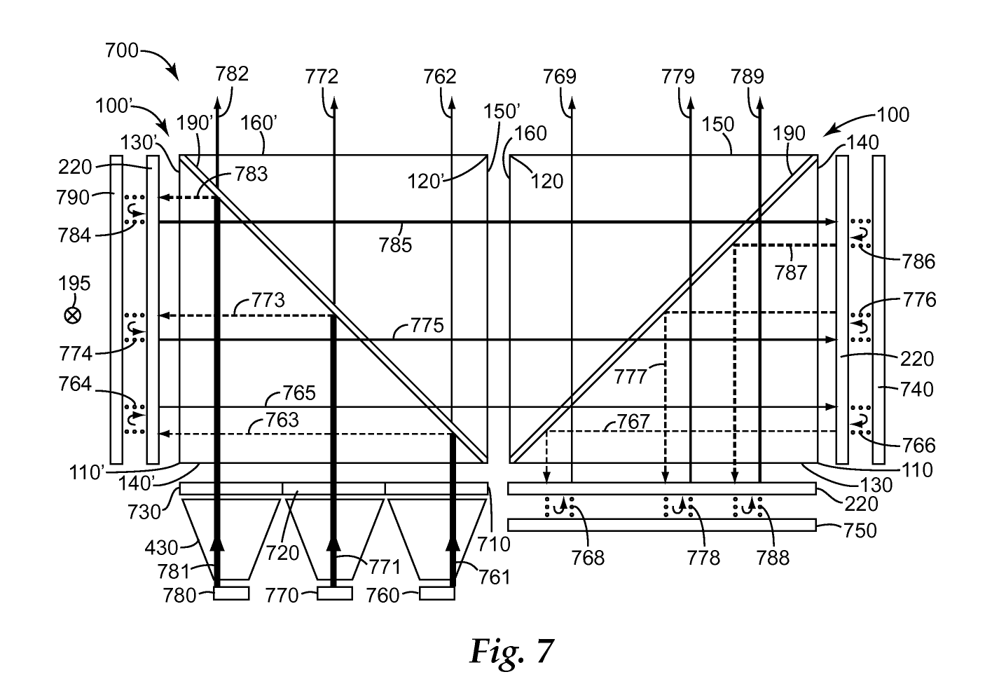

In one aspect, FIG. 7 is a top view schematic representations of an optical element configured as a color combiner 700 that includes a first PBS 100 and a second PBS 100′. Color combiner 700 can be used with a variety of light sources as described elsewhere. The paths of light rays of each polarization emitted from a first, a second and a third light source 740, 750, 760 are shown in FIG. 7, to more clearly illustrate the function of the various components of color combiner 700. First PBS 100 and second PBS 100′ include a first and second reflective polarizer 190, 190′ aligned to the first polarization state 195, disposed between the diagonal faces of first and second prisms 110, 120 and 110′, 120′, as described elsewhere.

A first, second and third wavelength selective filter 710, 720, 730 is disposed facing the second prism face 140′ of second PBS 100′. Each of the first, second and third wavelength selective filters 710, 720, 730 can be a color-selective dichroic filter selected to transmit a first, second and third wavelength spectrum of light, respectively, and reflect other wavelength spectrums of light. In one aspect, the first and second reflective polarizers 190, 190′ can comprise a polymeric multilayer optical film. In one embodiment, second reflective polarizer 190′ includes blue layers disposed proximate first, second, and third color-selective dichroic filters (710, 720, 730), and first reflective polarizer 190 includes blue layers disposed facing opposite second reflective polarizer 190′, as described elsewhere.

A first, a second, and a third polarization rotating reflector comprising a broadband mirror (740, 750, 790) is disposed facing the second and the first prism face 140, 130 of first PBS 100, and the first prism face 130′ of second PBS 100′, respectively. Each polarization rotating reflector further comprises a retarder 220 disposed between the respective prism face and the broadband mirror. Broadband mirrors 740, 750, 790 and retarders 220 serve to convert polarization states of light leaving and re-entering first and second PBS 100, 100′, as described elsewhere.

The retarder 220, color-selective filter (710, 720, 730), broadband mirrors (740, 750, 790), and first and second reflective polarizer 190, 190′ cooperate to transmit one polarization state of light through the fourth prism face 160′ of second PBS 100′ and third prism face 150 of first PBS 100, and recycle the other polarization state of light, as described elsewhere. In one embodiment described below, each retarder 220 in color combiner 700 is a quarter-wave retarder orientated at approximately 45 degrees to the first polarization state 195.

According to another aspect, an optional light tunnel 430 or assemblies of lenses (not shown) can be provided for each of the first, second and third light sources 740, 750, 760, as described elsewhere with reference to FIG. 4, the disclosure of which applies equally to FIG. 7.

The path of a first color light 761 will now be described with reference to FIG. 7, where unpolarized first color light 761 exits fourth prism face 160′ of second PBS 100′ as p-polarized first color light 762 and third prism face 150 of first PBS 100 as p-polarized first color light 769.

Unpolarized first color light 761 from first light source 760 passes through first color-selective dichroic filter 710, quarter-wave retarder 220, enters second PBS 100′ through second prism face 140′, intercepts second reflective polarizer 190′, and is split into p-polarized first color light 762 and s-polarized first color light 763. P-polarized first color light 762 passes through second reflective polarizer 190′, and exits second PBS 100′ through fourth prism face 160′ as p-polarized first color light 762.

S-polarized first color light 763 reflects from second reflective polarizer 190′, exits second PBS 100′ through first prism face 130′, changes to circular polarized first color light 764 as it passes through quarter-wave retarder 220, reflects from third broadband mirror 790 changing the direction of circular polarization, changes to p-polarized first color light 765 as it passes through quarter-wave retarder 220, and enters second PBS 100′ through first prism face 130′. P-polarized first color light 765 passes through second reflective polarizer 190′, exits second PBS 100′ through third prism face 150′, enters first PBS 100 through fourth prism face 160, passes through first reflective polarizer 190, and exits first PBS 100 through second prism face 140. P-polarized first color light 765 changes to circularly polarized light 766 as it passes through quarter-wave retarder 220, reflects from first broadband mirror 740 changing state of circular polarization, and changes to s-polarized first color light 767 as it passes through quarter-wave retarder 220. S-polarized first color light 767 enters first PBS 100 through second prism face 140, reflects from first reflective polarizer 190, exits first PBS 100 through first prism face 130, and changes to circularly polarized light 768 as it passes through quarter-wave retarder 220. Circularly polarized light 768 reflects from second broadband mirror 750 changing state of circular polarization, changes to p-polarized first color light 769 as it passes through quarter-wave retarder 220, enters first PBS 100 through first prism face 130, passes through first reflective polarizer 190, and exits first PBS 100 through third prism face 150 as p-polarized first color light 769.

The path of a second color light 771 will now be described with reference to FIG. 7, where unpolarized second color light 771 exits third prism face 150 of first PBS 100 as p-polarized second color light 779 and fourth prism face 160′ of second PBS 100′ as p-polarized second color light 772. It will be appreciated that the paths of first color light 761, second color light 771 and third color light 781 through color combiner 600 are similar, as seen in FIG. 7.

Unpolarized second color light 771 from second light source 770 passes through second color-selective dichroic filter 720, quarter-wave retarder 220, enters second PBS 100′ through second prism face 140′, intercepts second reflective polarizer 190′, and is split into p-polarized second color light 772 and s-polarized second color light 773. P-polarized second color light 772 passes through second reflective polarizer 190′, and exits second PBS 100′ through fourth prism face 160′ as p-polarized second color light 772.

S-polarized second color light 773 reflects from second reflective polarizer 190′, exits second PBS 100′ through first prism face 130′, changes to circular polarized second color light 774 as it passes through quarter-wave retarder 220, reflects from third broadband mirror 790 changing the direction of circular polarization, changes to p-polarized second color light 775 as it passes through quarter-wave retarder 220, and enters second PBS 100′ through first prism face 130′. P-polarized second color light 775 passes through second reflective polarizer 190′, exits second PBS 100′ through third prism face 150′, enters first PBS 100 through fourth prism face 160, passes through first reflective polarizer 190, and exits first PBS 100 through second prism face 140. P-polarized second color light 775 changes to circularly polarized light 776 as it passes through quarter-wave retarder 220, reflects from first broadband mirror 740 changing state of circular polarization, and changes to s-polarized second color light 777 as it passes through quarter-wave retarder 220. S-polarized second color light 777 enters first PBS 100 through second prism face 140, reflects from first reflective polarizer 190, exits first PBS 100 through first prism face 130, and changes to circularly polarized light 778 as it passes through quarter-wave retarder 220. Circularly polarized light 778 reflects from second broadband mirror 750 changing state of circular polarization, changes to p-polarized second color light 779 as it passes through quarter-wave retarder 220, enters first PBS 100 through first prism face 130, passes through first reflective polarizer 190, and exits first PBS 100 through third prism face 150 as p-polarized second color light 779.

The path of a third color light 781 will now be described with reference to FIG. 7, where unpolarized third color light 781 exits third prism face 150 of first PBS 100 as p-polarized third color light 789 and fourth prism face 160′ of second PBS 100′ as p-polarized third color light 782.

Unpolarized third color light 781 from third light source 780 passes through third color-selective dichroic filter 730, quarter-wave retarder 220, enters second PBS 100′ through second prism face 140′, intercepts second reflective polarizer 190′, and is split into p-polarized third color light 782 and s-polarized third color light 783. P-polarized third color light 782 passes through second reflective polarizer 190′, and exits second PBS 100′ through fourth prism face 160′ as p-polarized third color light 782.

S-polarized third color light 783 reflects from second reflective polarizer 190′, exits second PBS 100′ through first prism face 130′, changes to circular polarized third color light 784 as it passes through quarter-wave retarder 220, reflects from third broadband mirror 790 changing the direction of circular polarization, changes to p-polarized third color light 785 as it passes through quarter-wave retarder 220, and enters second PBS 100′ through first prism face 130′. P-polarized third color light 785 passes through second reflective polarizer 190′, exits second PBS 100′ through third prism face 150′, enters first PBS 100 through fourth prism face 160, passes through first reflective polarizer 190, and exits first PBS 100 through second prism face 140. P-polarized third color light 785 changes to circularly polarized light 786 as it passes through quarter-wave retarder 220, reflects from first broadband mirror 740 changing state of circular polarization, and changes to s-polarized third color light 787 as it passes through quarter-wave retarder 220. S-polarized third color light 787 enters first PBS 100 through second prism face 140, reflects from first reflective polarizer 190, exits first PBS 100 through first prism face 130, and changes to circularly polarized light 788 as it passes through quarter-wave retarder 220. Circularly polarized light 788 reflects from second broadband mirror 750 changing state of circular polarization, changes to p-polarized third color light 789 as it passes through quarter-wave retarder 220, enters first PBS 100 through first prism face 130, passes through first reflective polarizer 190, and exits first PBS 100 through third prism face 150 as p-polarized third color light 789.

In one embodiment, first color light 761 is green light, second color light 771 is blue light, and third color light 781 is red light. According to this embodiment, first color-selective dichroic filter 710 is a red and blue light reflecting and green light transmitting dichroic filter; second color-selective dichroic filter 720 is a green and red light reflecting and blue light transmitting dichroic filter; third color-selective dichroic filter 730 is a blue and green light reflecting and red light transmitting dichroic filter. According to this embodiment, the first polarization state of the blue second color light 771 is transmitted twice through the second reflective polarizer 190′ and twice through the first reflective polarizer 190; the second polarization state of the blue second color light 751 is reflected once by each of the second reflective polarizer 190′and the first reflective polarizer 190. The single reflection from each reflective polarizer is preferably a front surface reflection from the blue layers, which results from orientation of the reflective polarizers 190, 190′, as described elsewhere.

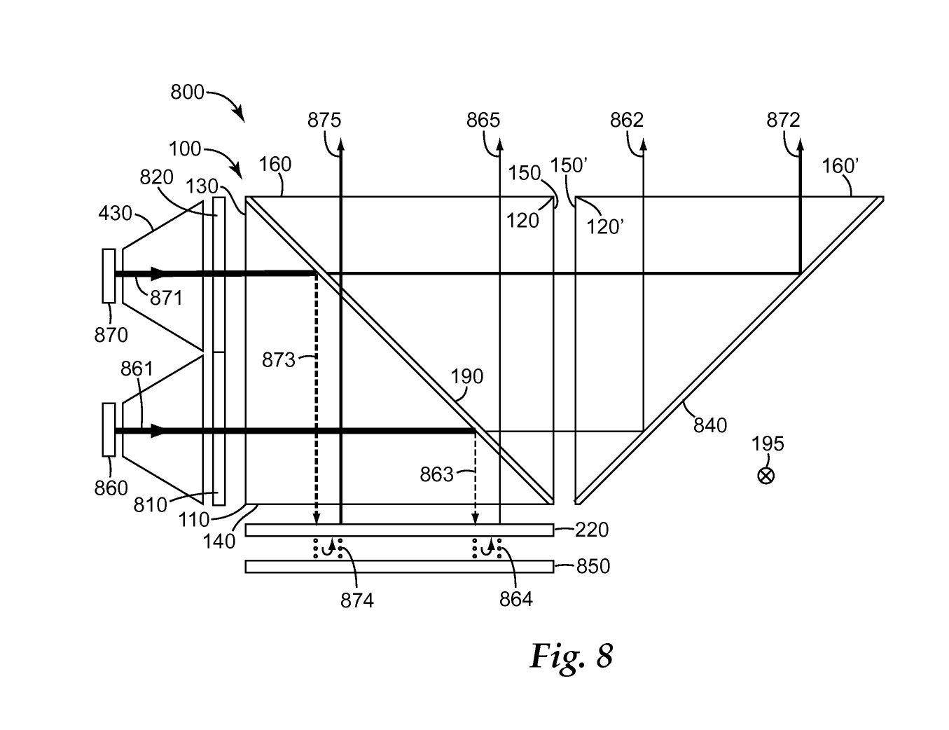

In one aspect, FIG. 8 is a top view schematic representation of an optical element configured as a color combiner 800 that includes a PBS 100 and a reflecting prism 120′ adjacent the third prism face 150 of PBS 100. Color combiner 800 can be used with a variety of light sources as described elsewhere. The paths of light rays of each polarization state emitted from a first and a second light source 860, 870 are shown in FIG. 8, to more clearly illustrate the function of the various components of color combiner 800. PBS 100 includes a reflective polarizer 190 aligned to the first polarization state 195, disposed between the diagonal faces of first and second prisms 110, 120, as described elsewhere. Reflecting prism 120′ redirects a portion of the light exiting PBS 100, as described elsewhere. Reflecting prism 120′ includes fifth prism face 150′, sixth prism face 160′ having a 90 degree angle between them, and diagonal prism face having a broadband mirror 840. Broadband mirror 840 can also be a pellicle, similar to the pellicle reflective polarizer as described elsewhere, and reflecting prism 120′ is not needed. In one embodiment, reflecting prism 120′ and second prism 120 can be a unitary optical component (not shown), such as a prism having three sides bounded by broadband mirror 840, reflective polarizer 190 and third and sixth prism faces 150, 160′.

A first and second wavelength-selective filter 810, 820 are disposed facing the first prism face 130. Each of the first and second wavelength-selective filters 810, 820 can be a color-selective dichroic filter selected to transmit a first and second wavelength spectrum of light, respectively, and reflect other wavelength spectrums of light. In one aspect, the reflective polarizer 190 can comprise a polymeric multilayer optical film. In one embodiment, reflective polarizer 190 includes blue layers disposed proximate first and second color-selective dichroic filters 810, 820, as described elsewhere.

A polarization rotating reflector comprising a broadband mirror 850 is disposed facing the second prism face 140 of PBS 100. The polarization rotating reflector further comprises a retarder 220 disposed between second prism face 140 and broadband mirror 850. Broadband mirror 850 and retarder 220 serve to convert polarization states of light leaving the PBS 100 through second prism face 140, and redirect the converted polarization state light back into the PBS 100, as described elsewhere.

The retarder 220, color-selective dichroic filter (810, 820), broadband mirrors (840, 850) and reflective polarizer 190 cooperate to transmit one polarization state of light through the fourth and sixth prism faces 160, 160′, and recycle the other polarization state of light, as described elsewhere. In one embodiment described below, each retarder 220 in color combiner 800 is a quarter-wave retarder orientated at approximately 45 degrees to the first polarization state 195. According to another aspect, an optional light tunnel 430 or assemblies of lenses (not shown) can be provided for each of the first and second light sources 860, 870, as described elsewhere.

The path of a first color light 861 will now be described with reference to FIG. 8, where unpolarized first color light 861 exits fourth prism face 160 as p-polarized first color light 865 and sixth prism face 160′ as p-polarized first color light 862.

First light source 860 injects unpolarized first color light 861 through first color-selective dichroic filter 810, enters PBS 100 through first prism face 130, intercepts reflective polarizer 190, and is split into p-polarized first color light 862 and s-polarized first color light 863. P-polarized first color light 862 passes through reflective polarizer 190, exits PBS 100 through third prism face 150, enters reflecting prism 120′ through fifth prism face 150′, reflects from broadband mirror 840, and exits reflecting prism 120′ through sixth prism face 160′ as p-polarized first color light 862.

S-polarized first color light 863 reflects from reflective polarizer 190, exits PBS 100 through second prism face 140, and changes to circularly polarized light 864 as it passes through quarter-wave retarder 220. Circularly polarized light 864 reflects from broadband mirror 850, changing state of circular polarization, and changes to p-polarized first color light 865 as it passes through quarter-wave retarder 220. P-polarized first color light 865 enters PBS 100 through second prism face 140, passes unchanged through reflective polarizer 190, and exits PBS 100 through fourth prism face 160 as p-polarized first color light 865.

The path of a second color light 871 will now be described with reference to FIG. 8, where unpolarized second color light 871 exits fourth prism face 160 as p-polarized second color light 875, and sixth prism face 160′ as p-polarized second color light 872.

Unpolarized second color light 871 from second light source 870 passes through second color-selective dichroic filter 820, enters PBS 100 through first prism face 130, intercepts reflective polarizer 190, and is split into p-polarized second color light 872 and s-polarized second color light 873. P-polarized second color light 872 passes through reflective polarizer 190, exits PBS 100 through third prism face 150, enters reflecting prism 120′ through fifth prism face 120′, reflects from broadband mirror 840, and exits reflecting prism 120′ through sixth prism face 160′ as p-polarized second color light 862.

S-polarized second color light 873 reflects from reflective polarizer 190, exits PBS 100 through second prism face 140, and changes to circularly polarized light 874 as it passes through quarter-wave retarder 220. Circularly polarized light 874 reflects from broadband mirror 850, changing state of circular polarization, and changes to p-polarized second color light 875 as it passes through quarter-wave retarder 220. P-polarized second color light 875 enters PBS 100 through second prism face 140, passes unchanged through reflective polarizer 190, and exits PBS 100 through fourth prism face 160 as p-polarized second color light 875.

In one embodiment, first color light 861 is green light and second color light 871 is magenta light. According to this embodiment, first color-selective dichroic filter 810 is a red and blue (i.e., magenta) light reflecting and green light transmitting dichroic filter; second color-selective dichroic filter 820 is a green light reflecting and magenta light transmitting dichroic filter. According to this embodiment, the first polarization state of the blue component of second color light 871 is transmitted twice and the second polarization state of the blue component of second color light 871 is reflected once by the reflective polarizer 190. The single reflection is preferably a front surface reflection from the blue layers, which results from orientation of the reflective polarizer 190, as described elsewhere.

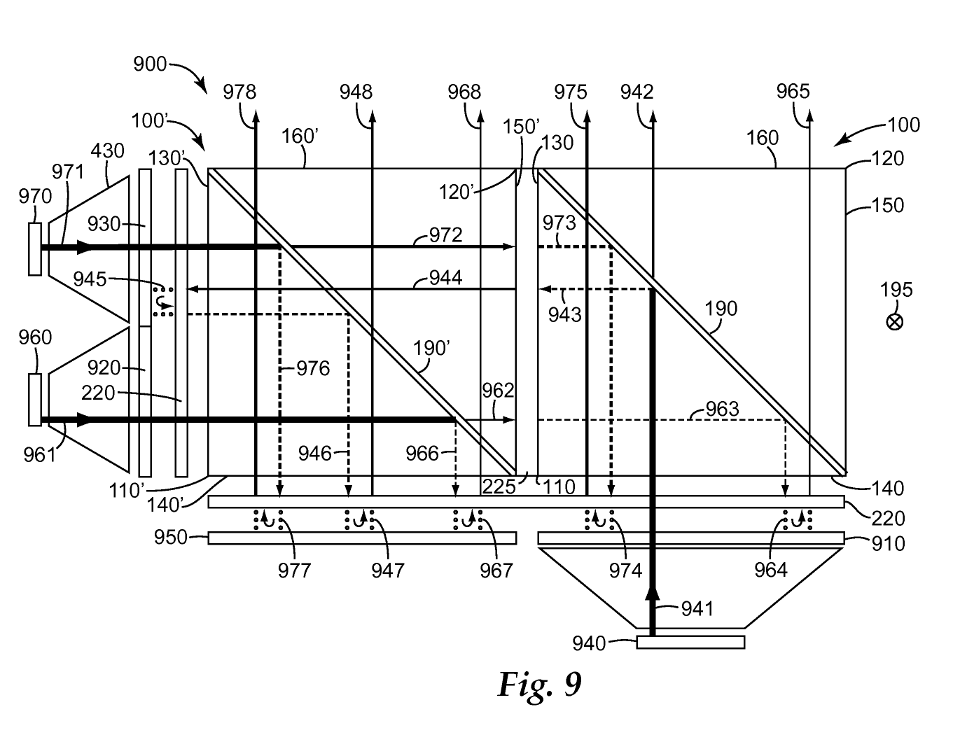

In one aspect, FIG. 9 is a top view schematic representation of an optical element configured as a color combiner 900 that includes a first PBS 100 and a second PBS 100′. Color combiner 900 can be used with a variety of light sources as described elsewhere. The paths of light rays of each polarization emitted from a first, a second and a third light source 940, 960, 970 are shown in FIG. 9, to more clearly illustrate the function of the various components of color combiner 900. First PBS 100 and second PBS 100′ include a first and second reflective polarizer 190, 190′ aligned to the first polarization state 195, disposed between the diagonal faces of first and second prisms 110, 120 and 110′, 120′, as described elsewhere.

A first wavelength selective filter 910 is disposed facing the second prism face 140 of first PBS 100. A second and a third wavelength selective filter 920, 930, is disposed facing the first prism face 130′ of second PBS 100′. Each of the first, second and third wavelength selective filters 910, 920, 930 can be a color-selective dichroic filter selected to transmit a first, second and third wavelength spectrum of light, respectively, and reflect other wavelength spectrums of light.

A retarder 220 is disposed facing each of the first, second and third color-selective filters (910, 920, 930). In some cases, as shown in FIG. 9, the retarder 220 can be a unitary retarder 220 that spans, for example, the first prism face 130′ of second PBS 100′. In some cases, a separate retarder 220 can be disposed adjacent each color-selective filter (910, 920, 930).

In one aspect, the first and second reflective polarizers 190, 190′ can comprise a polymeric multilayer optical film. In one embodiment, second reflective polarizer 190′ includes blue layers disposed proximate the second, and third color-selective dichroic filters (920, 930), and first reflective polarizer 190 includes blue layers disposed facing first color-selective dichroic filter 910, as described elsewhere.

A polarization rotating reflector comprising a broadband mirror 950 is disposed facing the second prism face 140′ of second PBS 100′. The polarization rotating reflector further comprises a retarder 220 disposed between the second prism face 140′ and the broadband mirror. Broadband mirrors 950 and retarder 220 serve to convert polarization states of light leaving and re-entering second PBS 100′, as described elsewhere.

The retarder 220, color-selective filter (910, 920, 930), broadband mirror 950, and first and second reflective polarizer 190, 190′ cooperate to transmit one polarization state of light through the fourth prism face 160′ of second PBS 100′ and fourth prism face 160 of first PBS 100, and recycle the other polarization state of light, as described elsewhere. In one embodiment described below, each retarder 220 in color combiner 900 is a quarter-wave retarder orientated at approximately 45 degrees to the first polarization state 195.

According to another aspect, an optional light tunnel 430 or assemblies of lenses (not shown) can be provided for each of the first, second and third light sources 940, 960, 970, as described elsewhere with reference to FIG. 4, the disclosure of which applies equally to FIG. 9.

Color combiner 900 further includes a half-wave retarder 225 disposed between the first and the second PBS 100, 100′. Half-wave retarder 225 cooperates with first and second polarizer 190, 190′ to convert the polarization state of light passing through it, and is also orientated at approximately 45 degrees to the first polarization state 195.

The path of a first color light 941 will now be described with reference to FIG. 9, where unpolarized first color light 941 exits fourth prism face 160 of first PBS 100 as p-polarized first color light 942 and fourth prism face 160′ of second PBS 100′ as p-polarized first color light 948.

Unpolarized first color light 941 from first light source 940 passes through first color-selective dichroic filter 910, quarter-wave retarder 220, enters first PBS 100 through second prism face 140, intercepts first reflective polarizer 190, and is split into p-polarized first color light 942 and s-polarized first color light 943. P-polarized first color light 942 passes through first reflective polarizer 190, exits first PBS 100 through fourth prism face 160 as p-polarized first color light 942.

S-polarized first color light 943 reflects from first reflective polarizer 190, exits first PBS 100 through first prism face 130, passes through half-wave retarder changing to p-polarized first color light 944, and enters second PBS 100′ through third prism face 150. P-polarized first color light 944 passes through second reflective polarizer 190′, exits second PBS 190′ through first prism face 130′, changes to circular polarized light 945 as it passes through quarter-wave retarder 220, reflects from either second or third color-selective dichroic filter 920, 930 changing the direction of circular polarization, and becomes s-polarized first color light 946 after passing through quarter-wave retarder 220. S-polarized first color light enters second PBS 100′ through first prism face 130′, reflects from second reflective polarizer 190′, passes through second prism face 140′ of second PBS 100′, and passes through quarter-wave retarder 220, changing to circular polarized light 947. Circular polarized light 947 reflects from broadband mirror 950, changing the direction of circular polarization, becomes p-polarized first color light 948 after passing through quarter-wave retarder 220, enters second PBS 100′ through second prism face 140′, passes through second reflective polarizer 190′, and exits second PBS 100′ through fourth prism face 160′ as p-polarized first color light 948.

The path of a second color light 961 will now be described with reference to FIG. 9, where unpolarized first color light 961 exits fourth prism face 160 of first PBS 100 as p-polarized second color light 965 and fourth prism face 160′ of second PBS 100′ as p-polarized second color light 968. It will be appreciated that the paths of second color light 961 and third color light 971 through color combiner 900 are similar, as seen in FIG. 9.

Unpolarized second color light 961 from second light source 960 passes through second color-selective dichroic filter 920, quarter-wave retarder 220, enters second PBS 100′ through first prism face 130′, intercepts second reflective polarizer 190′, and is split into p-polarized second color light 962 and s-polarized second color light 966. P-polarized second color light 962 passes through second reflective polarizer 190′, exits second PBS 100′ through third prism face 150′, changes to s-polarized second color light 963 as it passes through half-wave retarder 225, enters first PBS 100 through first prism face 130, reflects from first reflective polarizer 190, and exits first PBS 100 through second prism face 140. S-polarized second color light 963 passes through quarter-wave retarder 220, changes to circular polarized light 964, reflects from first color-selective dichroic filter 910 changing the direction of circular polarization, passes through quarter-wave retarder 220 and becomes p-polarized second color light 965. P-polarized second color light 965 enters first PBS 100 through second prism face 140, passes through first reflective polarizer 190, and exits first PBS 100 through fourth prism face 160 as p-polarized second color light 965.

S-polarized second color light 966 reflects from second reflective polarizer 190′, exits second PBS 100′ through second prism face 140′, passes through quarter-wave retarder 220 changing to circular polarized light 967, reflects from broadband mirror 950 changing the direction of circular polarization, passes through quarter-wave retarder 220 changing to p-polarized second color light 968, and enters second PBS 100′ through second prism face 140′. P-polarized second color light 968 passes through second reflective polarizer 190′, and exits second PBS 100′ through fourth prism face 160′ as p-polarized second color light 968.

The path of a third color light 971 will now be described with reference to FIG. 9, where unpolarized third color light 971 exits fourth prism face 160 of first PBS 100 as p-polarized third color light 975 and fourth prism face 160′ of second PBS 100′ as p-polarized second color light 978.

Unpolarized third color light 971 from third light source 970 passes through third color-selective dichroic filter 930, quarter-wave retarder 220, enters second PBS 100′ through first prism face 130′, intercepts second reflective polarizer 190′, and is split into p-polarized third color light 972 and s-polarized third color light 976. P-polarized third color light 972 passes through second reflective polarizer 190′, exits second PBS 100′ through third prism face 150′, changes to s-polarized third color light 973 as it passes through half-wave retarder 225, enters first PBS 100 through first prism face 130, reflects from first reflective polarizer 190, and exits first PBS 100 through second prism face 140. S-polarized third color light 973 passes through quarter-wave retarder 220, changes to circular polarized light 974, reflects from first color-selective dichroic filter 910 changing the direction of circular polarization, passes through quarter-wave retarder 220 and becomes p-polarized third color light 975. P-polarized third color light 975 enters first PBS 100 through second prism face 140, passes through first reflective polarizer 190, and exits first PBS 100 through fourth prism face 160 as p-polarized third color light 975.

S-polarized third color light 976 reflects from second reflective polarizer 190′, exits second PBS 100′ through second prism face 140′, passes through quarter-wave retarder 220 changing to circular polarized light 977, reflects from broadband mirror 950 changing the direction of circular polarization, passes through quarter-wave retarder 220 changing to p-polarized third color light 978, and enters second PBS 100′ through second prism face 140′. P-polarized third color light 978 passes through second reflective polarizer 190′, and exits second PBS 100′ through fourth prism face 160′ as p-polarized third color light 978.

In one embodiment, first light source 940 emits green light, second light source 960 emits blue light, and third color light source 970 is red light. According to this embodiment, first color-selective dichroic filter 910 is a red and blue light reflecting and green light transmitting dichroic filter; second color-selective dichroic filter 920 is a green and red light reflecting and blue light transmitting dichroic filter; third color-selective dichroic filter 930 is a blue and green light reflecting and red light transmitting dichroic filter. According to this embodiment, the p-polarization state of the blue color light from second light source 960 is transmitted twice through the second reflective polarizer 190′ and once through the first reflective polarizer 190; the s-polarization state of the blue color light from second light source 960 is reflected once by the second reflective polarizer 190′ and once from the first reflective polarizer 190. The reflections are preferably a front surface reflection from the blue layers, which results from orientation of the reflective polarizers 190, 190′, as described elsewhere.

In one embodiment, a fourth color light (not shown) can also be injected into the color combiner 900. In this embodiment, the polarization rotating reflector comprises a fourth color-selective dichroic filter that replaces the broadband mirror 950 described above, an optional light tunnel, and a fourth light source arranged in a manner similar to the first, second and third (940, 960, 970) light sources, optional light tunnels 430, and color-selective dichroic filters (910, 920, 930) shown in FIG. 9. Fourth color-selective dichroic filter reflects first, second and third color lights (941, 961, 971), and transmits fourth color light (not shown). In this embodiment, fourth color light also passes through fourth prism face 160 of first PBS 100 and fourth prism face 160′ of second PBS 100′ in the p-polarization state.

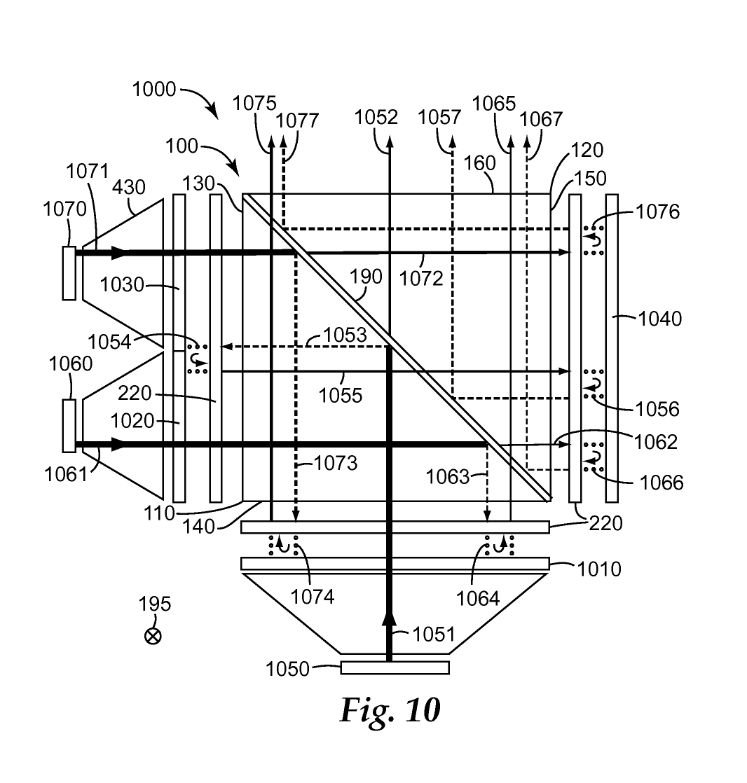

In one aspect, FIG. 10 is a top view schematic representation of an optical element configured as a color combiner 1000 that includes a PBS 100. Color combiner 1000 can be used with a variety of light sources as described elsewhere. The paths of light rays of each polarization state emitted from a first, a second, and a third light source (1050, 1060, 1070) are shown in FIG. 10, to more clearly illustrate the function of the various components of color combiner 1000. PBS 100 includes a reflective polarizer 190 aligned to the first polarization state 195, disposed between the diagonal faces of first and second prisms 110, 120, as described elsewhere.

A first wavelength-selective filter 1010 is disposed facing the second prism face 140, and a second and a third wavelength-selective filter 1020, 1030 are disposed facing the first prism face 130. Each of the first, second, and third wavelength-selective filters (1010, 1020, 1030) can be a color-selective dichroic filter selected to transmit a first, a second, and a third wavelength spectrum of light, respectively, and reflect other wavelength spectrums of light. In one aspect, the reflective polarizer 190 can comprise a polymeric multilayer optical film. In one embodiment, reflective polarizer 190 includes blue layers disposed proximate first, second, and third color-selective dichroic filters (1010, 1020, 1030), as described elsewhere.

A retarder 220 is disposed facing each of the first, second and third color-selective filters (1010, 1020, 1030). In some cases, as shown in FIG. 10, the retarder 220 can be a unitary retarder 220 that spans, for example, the first prism face 130 of first PBS 100. In some cases, a separate retarder 220 can be disposed adjacent each color-selective filter (1010, 1020, 1030).

A polarization rotating reflector comprising a broadband mirror 1040 is disposed facing the third prism face 150 of PBS 100. The polarization rotating reflector further comprises a retarder 220 disposed between third prism face 150 and broadband mirror 1040. Broadband mirror 1040 and retarder 220 serve to convert polarization states of light leaving the PBS 100 through third prism face 150, and redirect the converted polarization state light back into the PBS 100, as described elsewhere.

The retarder 220, color-selective dichroic filter (1010, 1020, 1030), broadband mirror 1040 and reflective polarizer 190 cooperate to transmit two orthogonal polarization states of light through the fourth prism faces 160 as a combined light, as described elsewhere. In one embodiment described below, each retarder 220 in color combiner 1000 is a quarter-wave retarder orientated at approximately 45 degrees to the first polarization state 195. According to another aspect, an optional light tunnel 430 or assemblies of lenses (not shown) can be provided for each of the first, second, and third light sources (1050, 1060, 1070), as described elsewhere.

The path of a first color light 1051 will now be described with reference to FIG. 10, where unpolarized first color light 1051 exits fourth prism face 160 as p-polarized first color light 1052 and s-polarized first color light 1057.

First light source 1050 injects unpolarized first color light 1051 through first color-selective dichroic filter 1010 and quarter-wave retarder 220, enters PBS 100 through second prism face 140, intercepts reflective polarizer 190, and is split into p-polarized first color light 1052 and s-polarized first color light 1053. P-polarized first color light 1052 passes through reflective polarizer 190, and exits PBS 100 through fourth prism face 160 as p-polarized first color light 1052.

S-polarized first color light 1053 reflects from reflective polarizer 190, exits PBS 100 through first prism face 130, and changes to circularly polarized light 1054 as it passes through quarter-wave retarder 220. Circularly polarized light 1054 is reflected from either second or third color-selective dichroic filter (1020, 1030), changing state of circular polarization, and changes to p-polarized first color light 1055 as it passes through quarter-wave retarder 220. P-polarized first color light 1055 enters PBS 100 through first prism face 130, passes unchanged through reflective polarizer 190, exits PBS 100 through third prism face 150, and changes to circularly polarized light 1056 as it passes through quarter-wave retarder 220. Circularly polarized light 1056 is reflected from broadband mirror 1040, changing state of circular polarization, changes again to s-polarized first color light 1057 as it passes through quarter-wave retarder 220, enters PBS 100 through third prism face 150, reflects from reflective polarizer 190, and exits PBS 100 through fourth prism face 160 as s-polarized first color light 1057.

The path of a second color light 1061 will now be described with reference to FIG. 10, where unpolarized second color light 1061 exits fourth prism face 160 as p-polarized second color light 1065, and s-polarized second color light 1067.

Unpolarized second color light 1061 from second light source 1060 passes through second color-selective dichroic filter 1020, enters PBS 100 through first prism face 130, intercepts reflective polarizer 190, and is split into p-polarized second color light 1062 and s-polarized second color light 1063. P-polarized second color light 1062 passes through reflective polarizer 190, exits PBS 100 through third prism face 150, changes to circular polarized light 1066 as it passes through quarter-wave retarder 220, changes direction of circular polarization as it reflects from broadband mirror 1040, and becomes s-polarized second color light 1067 as it passes through quarter-wave retarder 220. S-polarized second color light 1067 enters PBS 100 through third prism face 150, reflects from reflective polarizer 190, and exits PBS 100 through fourth prism face 160 as s-polarized second color light 1067.

S-polarized second color light 1063 reflects from reflective polarizer 190, exits PBS 100 through second prism face 140, and changes to circularly polarized light 1064 as it passes through quarter-wave retarder 220. Circularly polarized light 1064 reflects from first color-selective dichroic filter 1010, changing state of circular polarization, and changes to p-polarized second color light 1065 as it passes through quarter-wave retarder 220. P-polarized second color light 1065 enters PBS 100 through second prism face 140, passes unchanged through reflective polarizer 190, and exits PBS 100 through fourth prism face 160 as p-polarized second color light 1065.

The path of a third color light 1071 will now be described with reference to FIG. 10, where unpolarized first color light 1071 exits fourth prism face 160 of first PBS 100 as p-polarized third color light 1075 and s-polarized third color light 1077. It will be appreciated that the paths of second color light 1061 and third color light 1071 through color combiner 1000 are similar, as seen in FIG. 10.

Unpolarized third color light 1071 from third light source 1070 passes through third color-selective dichroic filter 1030, enters PBS 100 through first prism face 130, intercepts reflective polarizer 190, and is split into p-polarized third color light 1072 and s-polarized third color light 1073. P-polarized third color light 1072 passes through reflective polarizer 190, exits PBS 100 through third prism face 150, changes to circular polarized light 1076 as it passes through quarter-wave retarder 220, changes direction of circular polarization as it reflects from broadband mirror 1040, and becomes s-polarized third color light 1077 as it passes through quarter-wave retarder 220. S-polarized third color light 1077 enters PBS 100 through third prism face 150, reflects from reflective polarizer 190, and exits PBS 100 through fourth prism face 160 as s-polarized third color light 1077.

S-polarized third color light 1073 reflects from reflective polarizer 190, exits PBS 100 through second prism face 140, and changes to circularly polarized light 1074 as it passes through quarter-wave retarder 220. Circularly polarized light 1074 reflects from first color-selective dichroic filter 1010, changing state of circular polarization, and changes to p-polarized third color light 1075 as it passes through quarter-wave retarder 220. P-polarized third color light 1075 enters PBS 100 through second prism face 140, passes unchanged through reflective polarizer 190, and exits PBS 100 through fourth prism face 160 as p-polarized third color light 1075.

In one embodiment, first color light 1051 is green light, second color light 1061 is blue light, and third color light 1071 is red light. According to this embodiment, first color-selective dichroic filter 1010 is a red and blue (i.e., magenta) light reflecting and green light transmitting dichroic filter; second color-selective dichroic filter 1020 is a green and red light reflecting and blue light transmitting dichroic filter; and third color-selective dichroic filter 1030 is a green and blue light reflecting and red light transmitting dichroic filter. According to this embodiment, the first polarization state of the blue second color light 1061 is transmitted twice and the second polarization state of the blue second color light 1061 is reflected twice by the reflective polarizer 190. The first reflection is preferably a front surface reflection from the blue layers, which results from orientation of the reflective polarizer 190, as described elsewhere.

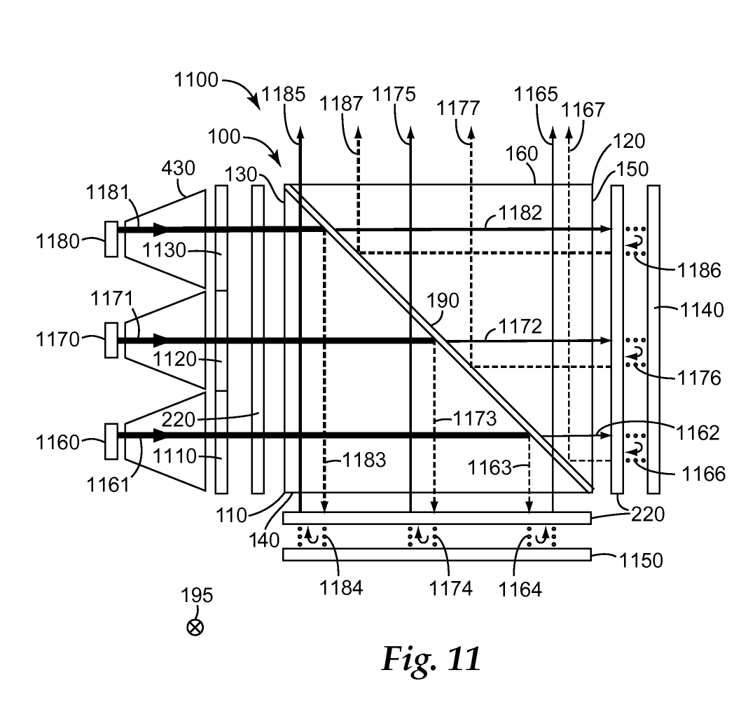

In one aspect, FIG. 11 is a top view schematic representation of an optical element configured as a color combiner 1100 that includes a PBS 100. Color combiner 1100 can be used with a variety of light sources as described elsewhere. The paths of light rays of each polarization state emitted from a first, a second, and a third light source (1160, 1170, 1180) are shown in FIG. 11, to more clearly illustrate the function of the various components of color combiner 1100. PBS 100 includes a reflective polarizer 190 aligned to the first polarization state 195, disposed between the diagonal faces of first and second prisms 110, 120, as described elsewhere.

A first, a second and a third wavelength-selective filter (1110, 1120, 1130) are disposed facing the first prism face 130. Each of the first, second, and third wavelength-selective filters (1110, 1120, 1130) can be a color-selective dichroic filter selected to transmit a first, a second, and a third wavelength spectrum of light, respectively, and reflect other wavelength spectrums of light. In one aspect, the reflective polarizer 190 can comprise a polymeric multilayer optical film. In one embodiment, reflective polarizer 190 includes blue layers disposed proximate first, second, and third color-selective dichroic filters (1110, 1120, 1130), as described elsewhere.

A retarder 220 is disposed facing each of the first, second and third color-selective filters (1110, 1120, 1130). In some cases, as shown in FIG. 11, the retarder 220 can be a unitary retarder 220 that spans, for example, the first prism face 130 of first PBS 100. In some cases, a separate retarder 220 can be disposed adjacent each color-selective filter (1110, 1120, 1130).

A polarization rotating reflector comprising a broadband mirror 1140, 1150 is disposed facing the second and third prism face (140, 150), respectively, of PBS 100. The polarization rotating reflector further comprises a retarder 220 disposed between the respective prism face and broadband mirror. Broadband mirror 1140, 1150 and retarders 220 serve to convert polarization states of light leaving the PBS 100, and redirect the converted polarization state light back into the PBS 100, as described elsewhere.

The retarder 220, color-selective dichroic filter (1110, 1120, 1130), broadband mirror (1140, 1150), and reflective polarizer 190 cooperate to transmit two orthogonal polarization states of light through the fourth prism face 160 as a combined light, as described elsewhere. In one embodiment described below, each retarder 220 in color combiner 1100 is a quarter-wave retarder orientated at approximately 45 degrees to the first polarization state 195. According to another aspect, an optional light tunnel 430 or assemblies of lenses (not shown) can be provided for each of the first, second, and third light sources (1160, 1170, 1180), as described elsewhere.

The path of a first color light 1161 will now be described with reference to FIG. 11, where unpolarized first color light 1161 exits fourth prism face 160 as p-polarized first color light 1165 and s-polarized first color light 1167. It will be appreciated that the paths of second color light 1171 and third color light 1181 through color combiner 1100 are similar, as seen in FIG. 11. For the sake of brevity, only the path of the first color light 1161 through color combiner 1100 is described below.

Unpolarized first color light 1161 from first light source 1160 passes through first color-selective dichroic filter 1110, enters PBS 100 through first prism face 130, intercepts reflective polarizer 190, and is split into p-polarized first color light 1162 and s-polarized first color light 1163. P-polarized first color light 1162 passes through reflective polarizer 190, exits PBS 100 through third prism face 150, changes to circular polarized light 1166 as it passes through quarter-wave retarder 220, changes direction of circular polarization as it reflects from broadband mirror 1140, and becomes s-polarized first color light 1167 as it passes through quarter-wave retarder 220. S-polarized first color light 1167 enters PBS 100 through third prism face 150, reflects from reflective polarizer 190, and exits PBS 100 through fourth prism face 160 as s-polarized first color light 1167.

S-polarized first color light 1163 reflects from reflective polarizer 190, exits PBS 100 through second prism face 140, and changes to circularly polarized light 1164 as it passes through quarter-wave retarder 220. Circularly polarized light 1164 reflects from broadband mirror 1150, changing state of circular polarization, and changes to p-polarized first color light 1165 as it passes through quarter-wave retarder 220. P-polarized first color light 1165 enters PBS 100 through second prism face 140, passes unchanged through reflective polarizer 190, and exits PBS 100 through fourth prism face 160 as p-polarized first color light 1165.

In one embodiment, first color light 1161 is green light, second color light 1171 is blue light, and third color light 1181 is red light. According to this embodiment, first color-selective dichroic filter 1110 is a red and blue (i.e., magenta) light reflecting and green light transmitting dichroic filter; second color-selective dichroic filter 1120 is a green and red light reflecting and blue light transmitting dichroic filter; and third color-selective dichroic filter 1130 is a green and blue light reflecting and red light transmitting dichroic filter. According to this embodiment, the first polarization state of the blue second color light 1161 is transmitted twice and the second polarization state of the blue second color light 1161 is reflected twice by the reflective polarizer 190. The first reflection is preferably a front surface reflection from the blue layers, which results from orientation of the reflective polarizer 190, as described elsewhere.

In one embodiment, a fourth color light (not shown) can also be injected into the color combiner 1100. In this embodiment, one the polarization rotating reflectors comprises a fourth color-selective dichroic filter that replaces the broadband mirror 1140, 1150 described above, an optional light tunnel, and a fourth light source arranged in a manner similar to the first, second and third (1160, 1170, 1180) light sources, optional light tunnels 430, and color-selective dichroic filters (1110, 1120, 1130) shown in FIG. 11. Fourth color-selective dichroic filter reflects first, second and third color lights (1160, 1170, 1180), and transmits fourth color light (not shown). In this embodiment, fourth color light also passes through fourth prism face 160 of first PBS 100.

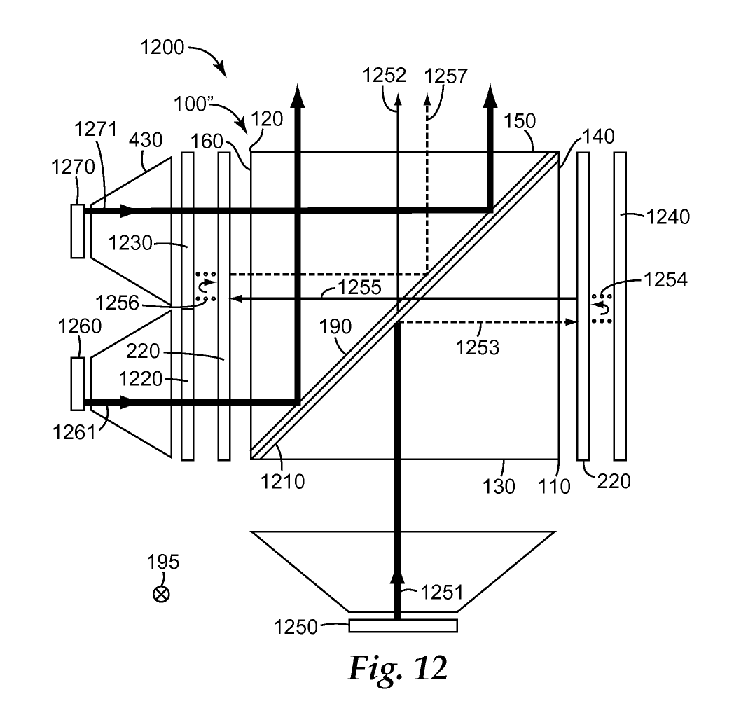

In one aspect, FIG. 12 is a top view schematic representation of an optical element configured as a color combiner 1200 that includes a PBS 100. Color combiner 1200 can be used with a variety of light sources as described elsewhere. The paths of light rays of each polarization state emitted from a first, a second, and a third light source (1250, 1260, 1270) are shown in FIG. 12, to more clearly illustrate the function of the various components of color combiner 1200. PBS 100 includes a reflective polarizer 190 aligned to the first polarization state 195, disposed between the diagonal faces of first and second prisms 110, 120, as described elsewhere.

A first wavelength-selective filter 1210 is disposed adjacent the reflective polarizer 190 and facing the first and second prism face (130, 140), and a second and a third wavelength-selective filter 1220, 1230 are disposed facing the fourth prism face 160. Each of the first, second, and third wavelength-selective filters (1210, 1220, 1230) can be a color-selective dichroic filter selected to transmit a first, a second, and a third wavelength spectrum of light, respectively, and reflect other wavelength spectrums of light. In one aspect, the reflective polarizer 190 can comprise a polymeric multilayer optical film. In one embodiment, reflective polarizer 190 includes blue layers disposed proximate first color-selective dichroic filter 1210, as described elsewhere.

A retarder 220 is disposed facing each of the second and third color-selective filters (1220, 1230). In some cases, as shown in FIG. 12, the retarder 220 can be a unitary retarder 220 that spans, for example, the fourth prism face 160 of first PBS 100. In some cases, a separate retarder 220 can be disposed adjacent each color-selective filter (1220, 1230).

A polarization rotating reflector comprising a broadband mirror 1240 is disposed facing the second prism face 140 of PBS 100. The polarization rotating reflector further comprises a retarder 220 disposed between second prism face 140 and broadband mirror 1240. Broadband mirror 1240 and retarder 220 serve to convert polarization states of light leaving the PBS 100 through second prism face 140, and redirect the converted polarization state light back into the PBS 100, as described elsewhere.

The retarder 220, color-selective dichroic filter (1210, 1220, 1230), broadband mirror 1240 and reflective polarizer 190 cooperate to transmit two orthogonal polarization states of light through the third prism face 150 as a combined light, as described elsewhere. In one embodiment described below, each retarder 220 in color combiner 1200 is a quarter-wave retarder orientated at approximately 45 degrees to the first polarization state 195. According to another aspect, an optional light tunnel 430 or assemblies of lenses (not shown) can be provided for each of the first, second, and third light sources (1250, 1260, 1270), as described elsewhere.

The path of a first color light 1251 will now be described with reference to FIG. 12, where unpolarized first color light 1251 exits third prism face 150 as p-polarized first color light 1252 and s-polarized first color light 1257.

First light source 1250 injects unpolarized first color light 1251 into PBS 100 through first prism face 130, through first color-selective dichroic filter 1210, intercepts reflective polarizer 190, and is split into p-polarized first color light 1252 and s-polarized first color light 1253. P-polarized first color light 1252 passes through reflective polarizer 190, and exits PBS 100 through fourth prism face 160 as p-polarized first color light 1252.

S-polarized first color light 1253 reflects from reflective polarizer 190, passes through first color-selective dichroic filter 1210, exits PBS 100 through second prism face 140, and changes to circularly polarized light 1254 as it passes through quarter-wave retarder 220. Circularly polarized light 1254 is reflected from broadband mirror 1240, changing state of circular polarization, and changes to p-polarized first color light 1255 as it passes through quarter-wave retarder 220. P-polarized first color light 1255 enters PBS 100 through second prism face 140, passes unchanged through first color-selective dichroic filter 1210 and reflective polarizer 190, exits PBS 100 through fourth prism face 160, and changes to circularly polarized light 1256 as it passes through quarter-wave retarder 220. Circularly polarized light 1256 is reflected from either second or third color-selective dichroic filter (1220, 1230), changing state of circular polarization, changes again to s-polarized first color light 1257 as it passes through quarter-wave retarder 220, enters PBS 100 through fourth prism face 160, reflects from reflective polarizer 190, and exits PBS 100 through third prism face 150 as s-polarized first color light 1257.

The path of a second color light 1261 will now be described with reference to FIG. 12, where unpolarized second color light 1261 exits third prism face 150 unchanged as unpolarized second color light 1261. It will be appreciated that the paths of second color light 1261 and third color light 1271 through color combiner 1200 are similar, as seen in FIG. 12. For the sake of brevity, only the path of the second color light 1261 through color combiner 1200 is described below.

Unpolarized second color light 1261 from second light source 1260 passes through second color-selective dichroic filter 1220, enters PBS 100 through fourth prism face 160, and intercepts reflective polarizer 190. The s-polarized state of second color light 1261 is reflected from reflective polarizer 190 and exits PBS 100 through third prism face 150. The p-polarized state of second color light 1261 is transmitted through reflective polarizer 190, reflects from first color-selective dichroic filter 1210, passes again through reflective polarizer, and exits PBS 100 through third prism face 150. Thus, it is seen that both s- and p-polarization states of the second color light 1261 exits PBS 100 through the third prism face 150.

In one embodiment, first color light 1251 is blue light, second color light 1261 is green light, and third color light 1271 is red light. According to this embodiment, first color-selective dichroic filter 1210 is a red and green light reflecting and blue light transmitting dichroic filter; second color-selective dichroic filter 1220 is a blue and red light reflecting and green light transmitting dichroic filter; and third color-selective dichroic filter 1230 is a green and blue light reflecting and red light transmitting dichroic filter.

Light sources in a color light combining system can be energized sequentially, as described in co-pending Published U.S. Patent Application No. US 2008/0285129. According to one aspect, the time sequence is synchronized with a transmissive or reflective imaging device in a projection system that receives a combined light output from the color light combining system. According to one aspect, the time sequence is repeated at rate that is fast enough so that an appearance of flickering of projected image is avoided, and appearances of motion artifacts such as color break up in a projected video image are avoided.

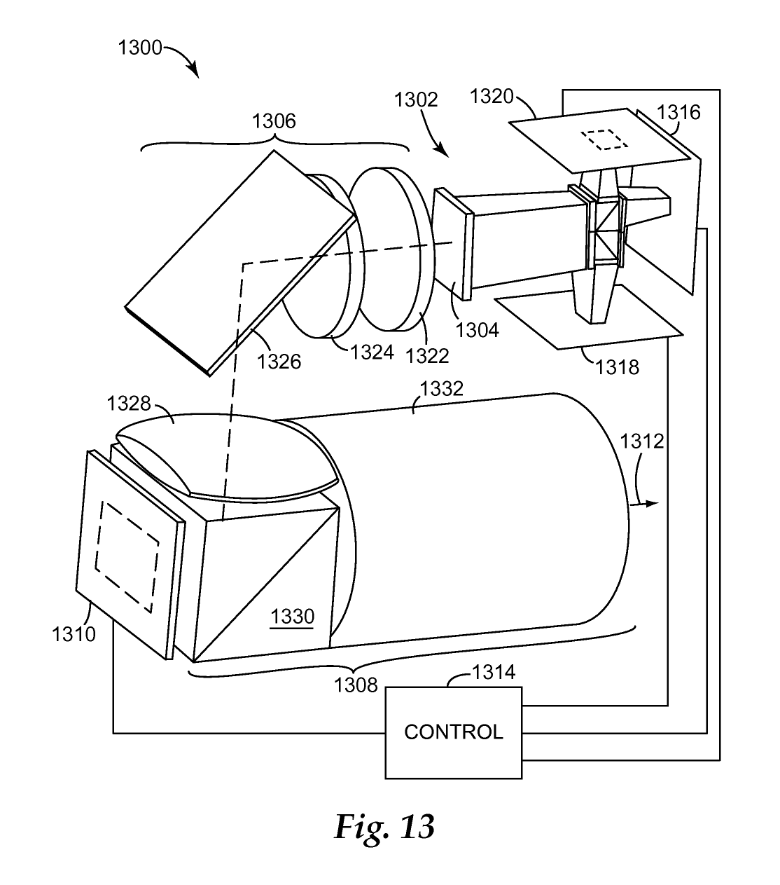

FIG. 13 illustrates a projector 1300 that includes a three color light combining system 1302. The three color light combining system 1302 provides a combined light output at output region 1304. In one embodiment, combined light output at output region 1304 is polarized. The combined light output at output region 1304 passes through light engine optics 1306 to projector optics 1308.

The light engine optics 1306 comprise lenses 1322, 1324 and a reflector 1326. The projector optics 1308 comprise a lens 1328, a PBS 1330 and projection lenses 1332. One or more of the projection lenses 1332 can be movable relative to the PBS 1330 to provide focus adjustment for a projected image 1312. A reflective imaging device 1310 modulates the polarization state of the light in the projector optics, so that the intensity of the light passing through the PBS 1330 and into the projection lens will be modulated to produce the projected image 1312. A control circuit 1314 is coupled to the reflective imaging device 1310 and to light sources 1316, 1318 and 1320 to synchronize the operation of the reflective imaging device 1310 with sequencing of the light sources 1316, 1318 and 1320. In one aspect, a first portion of the combined light at output region 1304 is directed through the projector optics 1308, and a second portion of the combined light output can be recycled back into color combiner 1302 through output region 1304. The second portion of the combined light can be recycled back into color combiner by reflection from, for example: a mirror, a reflective polarizer, a reflective LCD and the like. The arrangement illustrated in FIG. 13 is exemplary, and the light combining systems disclosed can be used with other projection systems as well. According to one alternative aspect, a transmissive imaging device can be used.

According to one aspect, a color light combining system as described above produces a three color (white) output. The system has high efficiency because polarization properties (reflection for S-polarized light and transmission for P-polarized light) of a polarizing beam splitter with reflective polarizer film have low sensitivity for a wide range of angles of incidence of source light. Additional collimation components can be used to improve collimation of the light from light sources in the color combiner. Without a certain degree of collimation, there will be significant light losses associated with variation of dichroic reflectivity as a function of angle of incidence (AOI), loss of TIR or increased evanescent coupling to frustrate the TIR, and/or degraded polarization discrimination and function in the PBS. In the present disclosure, polarizing beam splitters function as light pipes to keep light contained by total internal reflection, and released only through desired surfaces.

Although the present invention has been described with reference to preferred embodiments, workers skilled in the art will recognize that changes may be made in form and detail without departing from the spirit and scope of the invention.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer disposed to intercept the first light beam and the second light beam at an angle of approximately 45 degrees;
a second reflective polarizer disposed to intercept a second polarization state of the first and second light beam reflected from the first reflective polarizer,
at an angle of approximately 45 degrees;
a first retarder disposed between the first color-selective dichroic filter and the first reflective polarizer;
a second retarder disposed between the second color-selective dichroic filter and the first reflective polarizer;
a reflector disposed so that a line normal to the reflector intercepts the second reflective polarizer at an angle of approximately 45 degrees; and
a third retarder disposed between the second reflective polarizer and the reflector,
wherein the first and second reflective polarizers, the reflector, and the retarders are disposed to convert a second polarization state of the first and second light beam into a first polarization state of the first and second light beams, respectively.

2-3. (canceled)

4. An optical element, comprising:
a first reflective polarizer disposed to intercept a first light beam and a second light beam at an angle of approximately 45 degrees;
a second reflective polarizer disposed to intercept a second polarization state of the first and the second light beam reflected from the first reflective polarizer, at an angle of approximately 45 degrees;
a reflector disposed so that a line normal to the reflector intercepts the second reflective polarizer at an angle of approximately 45 degrees; and
a retarder disposed between the second reflective polarizer and the reflector,
wherein the first and second reflective polarizers, the reflector, and the retarder are disposed to convert a second polarization state of the first and the second light beam into a first polarization state of the first and the second light beams, respectively.

5. (canceled)

6. The optical element of claim 4, further comprising a third light beam capable of intercepting the first reflective polarizer at an angle of approximately 45 degrees, wherein the first and second reflective polarizers, the reflector, and the retarder are disposed to convert a second polarization state of the first, the second, and the third light beams into a first polarization state of the first, the second, and the third light beams, respectively.

7. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer disposed to intercept the first light beam and the second light beam at an angle of approximately 45 degrees;
a second reflective polarizer disposed to intercept a transmitted first and second light beams from the first reflective polarizer at an angle of approximately 45 degrees;
a first reflector disposed so that a line normal to the first reflector intercepts the first reflective polarizer at an angle of approximately 45 degrees;
a second reflector disposed so that a line normal to the second reflector intercepts the second reflective polarizer at an angle of approximately 45 degrees;
a first and a second retarder disposed between the first and second color-selective dichroic filters, respectively, and the first reflective polarizer;
a fourth, and a fifth retarder disposed between the first reflector and the first reflective polarizer, and the second reflector and the second reflective polarizer, respectively,
wherein the first and second reflective polarizers, the first and second reflectors, and the retarders are disposed to convert a second polarization state of the first and the second light beam into a first polarization state of the first and second light beams, respectively.

8. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer disposed to intercept the first light beam at an angle of approximately 45 degrees;
a second reflective polarizer disposed to intercept the second light beam at an angle of approximately 45 degrees;
a first reflector disposed so that a line normal to the first reflector intercepts the first reflective polarizer at an angle of approximately 45 degrees;
a second reflector disposed so that a line normal to the second reflector intercepts the second reflective polarizer at an angle of approximately 45 degrees;
a first and a second retarder disposed between the first and second color-selective dichroic filters, respectively, and the first reflective polarizer;
a fourth, and a fifth retarder disposed between the first reflector and the first reflective polarizer, and the second reflector and the second reflective polarizer, respectively,
wherein the first and second reflective polarizers, the first and second reflectors, and the retarders are disposed to convert a second polarization state of the first and the second light beam into a first polarization state of the first and second light beams, respectively.

9. The optical element of claim 7 or claim 8, further comprising:
a third color-selective dichroic filter having a third input surface, disposed to transmit a third light beam perpendicular to the third input surface; and
a third retarder disposed between the third color-selective dichroic filter and the second reflective polarizer,
wherein the first and second reflective polarizers, the first and second reflectors, and the retarders are disposed to convert a second polarization state of the first, the second, and the third light beam into a first polarization state of the first, the second, and the third light beams, respectively.

10-11. (canceled)

12. An optical element, comprising:
an unpolarized light beam perpendicular to a first input surface;
a first reflective polarizer disposed to intercept the unpolarized light beam at an angle of approximately 45 degrees;
a first reflector disposed so that a line normal to the first reflector intercepts the first reflective polarizer at an angle of approximately 45 degrees;
a second reflective polarizer disposed at an angle of approximately 90 degrees to the first reflective polarizer on a side opposite the first reflector;
a second and a third reflector disposed so that a line normal to each intercepts the second reflective polarizer at an angle of approximately 45 degrees; and
a first, a second, and a third retarder disposed adjacent each of the first, second and third reflectors, respectively,
wherein the first and second reflective polarizers and the retarders are disposed to convert a second polarization state of the unpolarized light beam into a first polarization state of the unpolarized light beam.

13. (canceled)

14. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer disposed to intercept the first and the second light beam at an angle of approximately 45 degrees;
a first reflector disposed so that a line normal to the first reflector intercepts the first reflective polarizer at an angle of approximately 45 degrees;
a second reflective polarizer disposed at an angle of approximately 90 degrees to the first reflective polarizer on a side opposite the first reflector;
a second and a third reflector disposed so that a line normal to each intercepts the second reflective polarizer at an angle of approximately 45 degrees; and
a first, a second, and a third retarder disposed adjacent each of the first, second and third reflectors, respectively,
wherein the first and second reflective polarizers and the retarders are disposed to convert a second polarization state of the first and the second light beam into a first polarization state of the first and the second light beam, respectively.

15. The optical element of claim 14, further comprising:
a third color-selective dichroic filter having a third input surface, disposed to transmit a third light beam perpendicular to the third input surface,
wherein the first and second reflective polarizers, the first and second reflectors and the retarders are disposed to convert a second polarization state of the first, the second, and the third light beam into a first polarization state of the first, the second, and the third light beams, respectively.

16. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer disposed to intercept the first light beam and the second light beam at an angle of approximately 45 degrees;
a first reflector disposed so that a line normal to the first reflector intersects the first reflective polarizer at an angle of approximately 45 degrees;
a second reflective polarizer disposed to intercept a transmitted first and second light beam from the first reflective polarizer at an angle of approximately 45 degrees;
a half-wave retarder disposed between the first reflective polarizer and the second reflective polarizer;
a first and a second quarter-wave retarder disposed between the first and the second color-selective dichroic filters, respectively, and the first reflective polarizer; and
a fourth quarter-wave retarder between the reflector and the first reflective polarizer,
wherein the first and second reflective polarizers, the reflectors, and the retarders are disposed to convert a second polarization state of the first and the second light beam into a first polarization state of the first and the second light beams, respectively.

17. The optical element of claim 16, further comprising:
a third color-selective dichroic filter having a third input surface, disposed to transmit a third light beam perpendicular to the third input surface; and
a third quarter-wave retarder disposed between the third color-selective dichroic filter and the second reflective polarizer;
wherein the first and second reflective polarizers, the reflectors, and the retarders are disposed to convert a second polarization state of the first, second and third light beam into a first polarization state of the first, second and third light beams, respectively.

18. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer disposed to intercept the first light beam at an angle of approximately 45 degrees;
a first reflector disposed so that a line normal to the first reflector intersects the first reflective polarizer at an angle of approximately 45 degrees;
a second reflective polarizer disposed to intercept the second light beam at an angle of approximately 45 degrees;
a half-wave retarder disposed between the first reflective polarizer and the second reflective polarizer;
a first and a second quarter-wave retarder disposed between the first and the second color-selective dichroic filters, respectively, and the first reflective polarizer; and
a fourth quarter-wave retarder between the reflector and the first reflective polarizer,
wherein the first and second reflective polarizers, the reflectors, and the retarders are disposed to convert a second polarization state of the first and the second light beam into a first polarization state of the first and the second light beams, respectively.

19. The optical element of claim 16, further comprising:
a third color-selective dichroic filter having a third input surface, disposed to transmit a third light beam perpendicular to the third input surface; and
a third quarter-wave retarder disposed between the third color-selective dichroic filter and the first reflective polarizer;
wherein the first and second reflective polarizers, the reflectors, and the retarders are disposed to convert a second polarization state of the first, second and third light beam into a first polarization state of the first, second and third light beams, respectively.

20-22. (canceled)

23. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a reflective polarizer, disposed to intercept the first light beam and the second light beam at an angle of approximately 45 degrees;
a first reflector disposed so that a line normal to the first reflector intercepts the reflective polarizer at an angle of approximately 45 degrees; and
a retarder disposed between the reflector and the reflective polarizer,
wherein the reflective polarizer, the first reflector, and the retarder are disposed to convert a second polarization state of the first and second light beam into a first polarization state of the first and second light beams, respectively.

24. The optical element of claim 23, wherein the second polarization state of the first and the second light beam reflects from the first reflector, and the first polarization state of the first and the second light beam reflects from a second reflector.

25. (canceled)

26. The optical element of claim 23, further comprising a first and second prism forming a polarizing beam splitter (PBS), the first and second dichroic filters disposed adjacent a first face of the first prism, the first mirror disposed adjacent a second face of the first prism, and wherein the reflective polarizer is disposed on a first diagonal of the PBS.

27. (canceled)

28. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a reflective polarizer, disposed to intercept the first light beam and the second light beam at an angle of approximately 45 degrees;
a first and a second retarder disposed between the first and the second color-selective dichroic filter and the reflective polarizer, respectively;
a first reflector disposed so that a line normal to the first reflector intercepts the reflective polarizer at an angle of approximately 45 degrees; and
a fourth retarder disposed between the reflective polarizer and the reflector,
wherein the reflective polarizer, the reflector and the retarders are disposed to combine the first and the second light beams into a combined unpolarized light beam.

29. The optical element of claim 28, further comprising:
a third color-selective dichroic filter having a third input surface, disposed to transmit a third light beam perpendicular to the third input surface; and
a third retarder disposed between the third color-selective dichroic filter and the reflective polarizer,
wherein the reflective polarizer, the reflector and the retarder are disposed to combine the first, the second, and the third light beam into a combined unpolarized light beam.

30-31. (canceled)

32. An optical element, comprising:
a first color-selective dichroic filter having a first input surface, disposed to transmit a first light beam perpendicular to the first input surface;
a reflective polarizer, disposed to intercept the first light beam at an angle of approximately 45 degrees;
a second color-selective dichroic filter having a second input surface disposed adjacent to the reflective polarizer, and opposite the first color-selective dichroic filter, the second color-selective dichroic filter disposed to transmit a second light beam;
a first retarder disposed between the first color-selective dichroic filter and the reflective polarizer;
a reflector disposed so that a line normal to the reflector intercepts the reflective polarizer at an angle of approximately 45 degrees; and
a second retarder disposed between the reflective polarizer and the reflector,
wherein the reflective polarizer, the reflector and the retarders are disposed to combine the first and the second light beam into a combined unpolarized light beam.

33-43. (canceled)
